(19) United States
(12) Patent Application Publication
(10) Pub. No.: US 2026/0093027 A1
(43) Pub. Date: Apr. 2, 2026

(54) METHODS, ARCHITECTURES, APPARATUSES AND SYSTEMS FOR ESTIMATION OF DOPPLER FREQUENCIES

(71) Applicant: InterDigital Patent Holdings, Inc., Wilmington, DE (US)

(72) Inventors: Fumihiro Hasegawa, Westmount (CA); Paul Marinier, Brossard (CA); Moon IL Lee, Melville, NY (US); Ghyslain Pelletier, Montreal (CA); Remun Koirala, London (GB); Tao Deng, New York, NY (US); Frank LaSita, Long Beach, NY (US)

(21) Appl. No.: 18/902,717

(22) Filed: Sep. 30, 2024

(51) Int. Cl. G01S 13/58; G01S 7/00; H04W 24/10

(52) U.S. Cl. CPC G01S 13/58; G01S 7/006; H04W 24/10

(57) ABSTRACT

Procedures, methods, architectures, apparatuses, systems, devices, and computer program products are provided for estimation of Doppler frequency. For example, a request for consistency, along with information indicating a time period associated with a consistency window, may be received from a wireless network. An expected Doppler frequency of a sensing target during the time period may be determined. During the time period, sensing measurements on a plurality of downlink reference signals (DL-RSs), each DL-RS of the plurality of DL-RSs associated with a respective subcarrier spacing (SCS), based on the expected Doppler frequency may be performed. A measurement report may be generated based on the sensing measurements and transmitted to a the wireless network.

### TECHNICAL FIELD

The present disclosure is generally directed to the fields of communications, software and encoding, including, for example, to methods, architectures, apparatuses, systems related to the estimation of Doppler frequencies.

### BACKGROUND

According to some approaches, methods of estimation of a Doppler frequency are deficient in that they do not provide for robust and repeatable estimation thereof. For example, certain approaches may not provide suitable accuracy and/or repeatability for robust and reliable estimation or determination of a Doppler frequency.

### SUMMARY

A method performed by a device is provided. For example, the method may include receiving, from the wireless network, a request for consistency, and information indicating a time period associated with a consistency window, and determining an expected doppler frequency of a sensing target during the time period. The method may also include performing, during the time period, sensing measurements on a plurality of downlink reference signals (DL-RSs), each DL-RS of the plurality of DL-RSs associated with a respective subcarrier spacing (SCS), based on the expected doppler frequency, and generating a measurement report based on the sensing measurements. The method may also include transmitting the measurement report to the wireless network.

A wireless transmit/receive unit (WTRU) is provided that is in communication with a wireless network and that includes a receiver and processing circuitry that are coupled to one another. The WTRU is configured to, for example, receive, from the wireless network, a request for consistency, and information indicating a time period associated with a consistency window, and determine an expected doppler frequency of a sensing target during the time period. The WTRU may also be configured to perform, during the time period, sensing measurements on a plurality of downlink reference signals (DL-RSs), each DL-RS of the plurality of DL-RSs associated with a respective subcarrier spacing (SCS), based on the expected doppler frequency, and generate a measurement report based on the sensing measurements. The WTRU may also be configured to transmit the measurement report to the wireless network.

In certain representative embodiments, the information indicating the time period comprises a time duration for which consistency must be maintained.

The method may also include receiving, and the WTRU may also be configured to receive, from the wireless network, a request to report information about a location of the WTRU, and transmitting, to the wireless network, information indicative of the location of the WTRU.

In certain representative embodiments, determining the expected doppler frequency of the sensing target during the time period comprises at least one of receiving, from the wireless network, the expected doppler frequency, or estimating the expected doppler frequency.

In certain representative embodiments, performing the sensing measurements may comprise identifying the plurality of DL-RSs, the respective SCSs, and a plurality of orthogonal frequency division multiplexing (OFDM) symbol indices associated with the plurality of DL-RSs based on the expected doppler frequency, and measuring a temporal separation between two OFDM symbols of corresponding OFDM symbol indexes of the plurality of OFDM symbol indices.

In certain representative embodiments, the plurality of DL-RSs may comprise a second plurality of DL-RSs, the respective SCSs comprise second respective SCSs, the measurements comprise second measurements, and the measurement report comprises a second measurement report. The method may also include, prior to determining an expected doppler frequency of a sensing target, performing first sensing measurements on a first plurality of DL-RSs, each associated with a first respective SCS based on the time period, generating a first measurement report based on the first sensing measurements, and transmitting the first measurement report to the wireless network.

The method may also include determining, and the WTRU may also be configured to determine, that a consistency condition is violated during the time period, and based on determining that the consistency condition is violated during the time period, may perform third sensing measurements on the first plurality of DL-RSs, each associated with a first respective SCS. The method may also include generating, and the WTRU may also be configured to generate, a third measurement report based on the third sensing measurements and transmitting the third measurement report to the wireless network.

In certain respective embodiments, the wireless network uses the measurement report to determine a velocity of the sensing target.

The method may also include determining, and the WTRU may also be configured to determine, at least one condition is met, and the conditions may include the expected Doppler frequency being below a threshold, or a standard deviation of a received power of a DL-RS from the plurality of DL-RSs is above a threshold. In certain representative embodiments, based on determining that the at least one of the conditions is met, the method may also include determining, and the WTRU may also be configured to determine, an average of the sensing measurements, and transmitting to the wireless network, as part of the measurement report, the average.

In certain representative embodiments, the expected Doppler frequency is received from the wireless network. The method may also include generating, and the WTRU may also be configured to generate, an estimated Doppler frequency, determining whether the estimated Doppler frequency corresponds to the expected Doppler frequency, and transmitting to the wireless network, as part of the measurement report, an indication of whether the estimated Doppler frequency corresponds to the expected Doppler frequency.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of symbol separation and SCS, and corresponding time span for OFDM symbols with DL-RS according to one or more embodiments;

FIG. 3 is an example of phase estimate for a path corresponding to a target which illustrates phase-wrap-around due to fast mobility of a target according to one or more embodiments;

FIG. 4 is an exemplary signaling diagram illustrating a request for sensing and response from a UE according to one or more embodiments;

FIG. 5 is an exemplary signaling diagram illustrating UE capability reporting, request for sensing and response at the UE according to one or more embodiments;

FIG. 6 is an exemplary hierarchical structure of PRS configurations according to one or more embodiments;

FIG. 7 is an example of different side channel spacings over time for two reference signals according to one or more embodiments;

FIG. 8 is an example of a relationship between bandwidth parts and side channel spacings according to one or more embodiments;

FIG. 9 is an example of channel impulse response estimates according to one or more embodiments;

FIG. 10 is an example of phase change in channel impulse responses across time according to one or more embodiments;

FIG. 11 is an example of channel impulse responses at different symbols and differential phase measurements according to one or more embodiments;

FIG. 12 is an example of timing measurement according to one or more embodiments;

FIG. 13 is an example of line of sight check and Doppler estimation according to one or more embodiments;

FIG. 14 is an example of interaction between a WTRU and a network according to one or more embodiments;

FIG. 15 is an exemplary signaling diagram illustrating signal flow between a WTRU and a network for Doppler estimation according to one or more embodiments; and

FIG. 16 is a flow diagram illustrating a method of determining a Doppler frequency according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

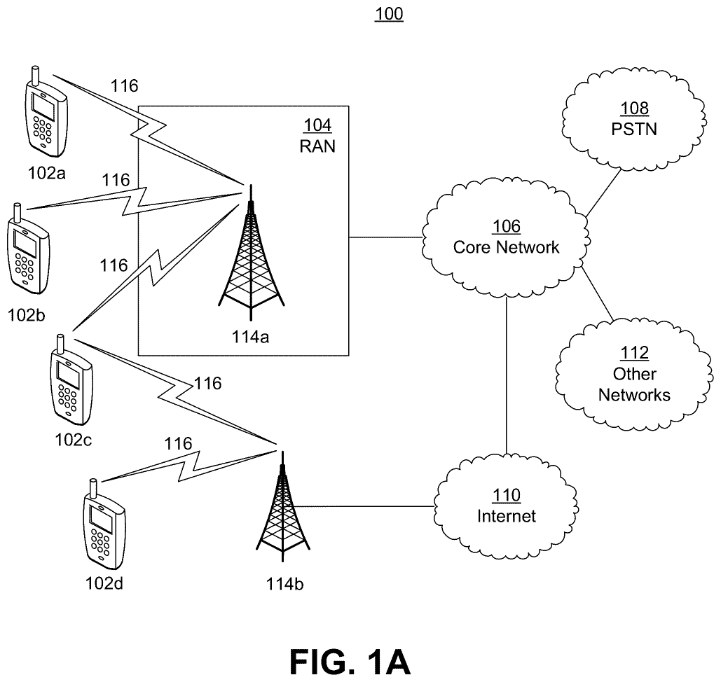

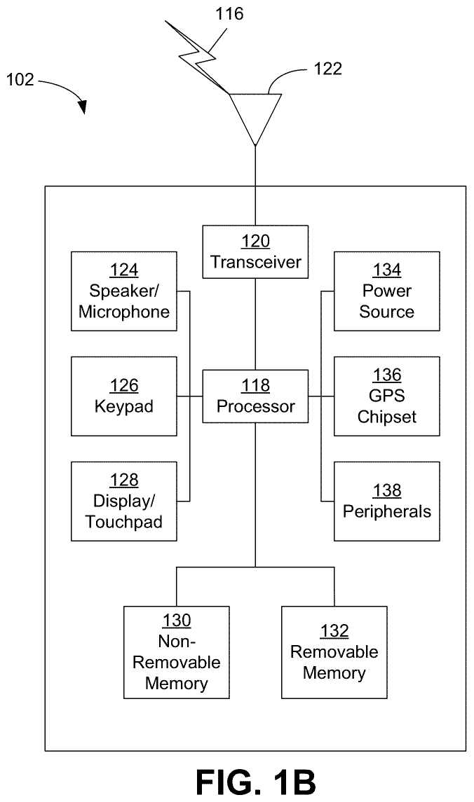

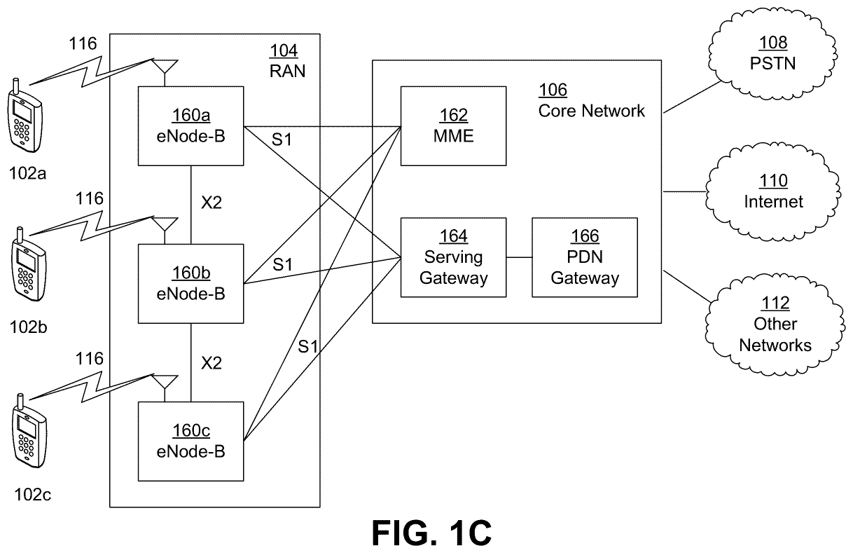

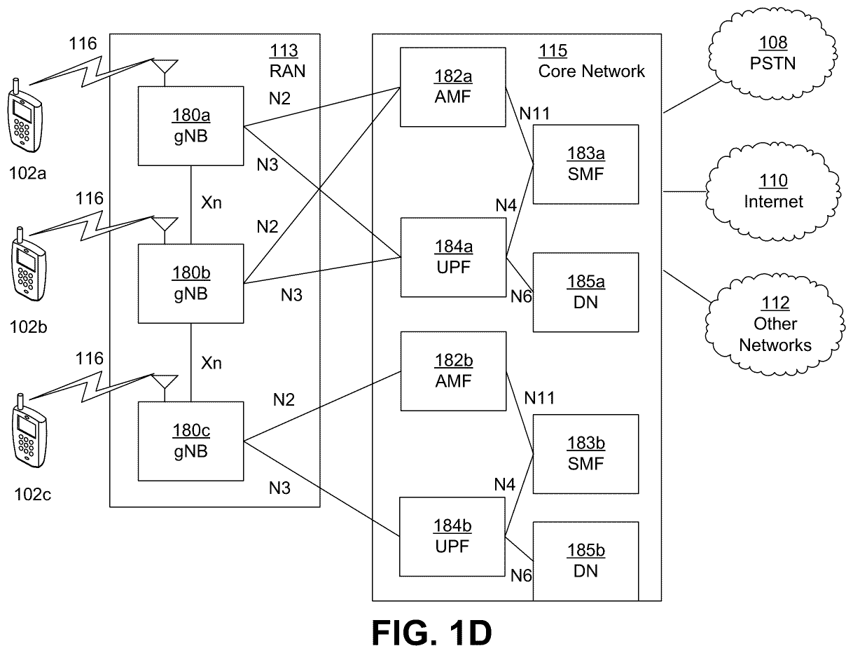

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable Radio Access Technology (‘RAT’) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the Node-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHZ channel to form a 40 MHz wide channel.

Very high throughput (VHT) STAs may support 20 MHZ, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHz, and 16 MHZ bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHZ to 923.5 MHz. In Japan, the available frequency bands are from 916.5 MHz to 927.5 MHZ. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Movement or mobility of a target object may introduce Doppler shift in a multipath measurement made by a UE. However, biases in measurements may be removed by differential processing to make an accurate estimate of the Doppler frequency. Differential processing of phase information may remove phase shift which may be introduced by movement or mobility of a UE. Phase shift may also be introduced by other impurities, which may include carrier frequency offset (‘CFO’) and/or phase offset (‘PO’). Differential processing may be carried out across two domains, which may for example be path and time. Differential processing between the line-of-sight (‘LOS’) path and the kth path (where k is not the LOS path index) may be used to cancel out constant phase shift which may appear across all paths. In addition, differential processing for each path across time may be performed to cancel out path specific phase terms, and it may expose phase shift introduced by UE movement (because a phase shift effect due to UE movement may appear across all paths) and target movement.

Subcarrier spacing (‘SCS’) may determine resolvable Doppler frequency. For example, a small SCS may give rise to a coarse granularity of phase measurement, which may be suitable for low mobility or low speed of movement, or a small Doppler frequency. A large SCS may give rise to a fine granularity of phase measurement, which may be suitable for high mobility or a high speed of movement, or a large Doppler frequency. The Doppler frequency may introduce a constant phase shift over a time period and it may be determined by observing the change in phase over a time, for example the slope of the change in phase over time.

A UE may send a request to the network for configuration. This request for configuration may include a request for downlink reference signal (‘DL-RS’) configurations, and/or uplink reference signal (‘UL-RS’) configurations in a physical uplink shared channel (‘PUSCH’), a physical upling control channel (‘PUCCH’), uplink control information (‘UCI’), a medium access control-control element (‘MAC-CE’), a radio resource control (‘RRC’) and/or an LTE positioning protocol (‘LPP’) message. The request from the UE may include a request for configuration of a measurement gap, a DL-RS processing window, and/or a window for transmission of UL-RS.

In some examples, the UE may send an acknowledgement message in a PUSCH or PUCCH message for the configuration granted or received from the network.

More than one condition or criterion may be used in a combination. The UE may be configured with more than one condition and associated UE behavior, and the UE may determine which behavior the UE shall use based on the applicable condition.

The UE may measure downlink reference signal (‘DL-RS’) inside or outside of an active bandwidth part (‘BWP’). In some examples, the UE may transmit an uplink reference signal (′UL-RS′) inside or outside of an active bandwidth part (‘BWP’).

The UE may be preconfigured with parameters, for example measurement gaps, DL-RS processing windows, DL-RS configurations, and/or UL-RS configurations via a semi-static message. This message may be, for example, an LPP and/or an RRC message.

Any actions the UE determines to take may be configured by the network. For example, the UE may be configured with a rule and according to the rule, the UE may determine to take an associated action.

In addition to the measurements made on the DL-RS, the UE may include at least one of the following cell-related measurements, which may include a Synchronization Signal Block Reference Signal Received Power (‘SSB RSRP’) from the serving cell with corresponding cell ID, an SSB RSRP from the neighboring cell or cells with a corresponding cell ID or IDs, the Reference Signal Received Power (‘RSRP’) of a Channel State Information Reference Signal (‘CSI-RS’) with the CSI-RS resource ID, and/or the Reference Signal Received Power (‘RSRP’) of the Demodulation Reference Signal (‘DM-RS’).

As described herein, the term, “network” may include the AMF, the Location Management Function (‘LMF’), a gNB and/or a Next Generation Radio Access Network (‘NG-RAN’). The terms “pre-configuration” and “configuration” may be used interchangeably herein. The terms “non-serving gNB” and “neighboring gNB” may also be used interchangeably herein.

The terms “gNB” and a Transmission and Reception Point (‘TRP’) may be used interchangeably in this disclosure, as may the terms “DL-RS” or “DL-RS resource”. Additionally, “DL-RS(s)” or “DL-RS resource(s)” may be used interchangeably herein. Such “DL-RS(s)” or “DL-RS resource(s)” may belong to different DL-RS resource sets. The terms “ID” and “index” may also be used interchangeably herein.

The phrases “measurement gap” and “measurement gap pattern” may be used interchangeably herein, and the phrase “measurement gap pattern” may include parameters such as measurement gap duration or measurement gap repetition period or measurement gap periodicity.

As described herein, an LMF is a non-limiting example of a node or entity (e.g., network node or entity) that may be used for or to support positioning or sensing. Any other node or entity may be substituted for LMF and still be consistent with that which is described herein.

The UE may receive a preconfigured threshold or thresholds from the network, for example the LMF and/or gNB. A line of sight (‘LOS’) indicator may be a hard indicator (e.g., 1 or 0) or soft indicator (e.g., 0, 0.1, 0.2 . . . , 1) and it may indicate the likelihood of the presence of an LOS path between a Transmission and Reception Point (‘TRP’) and a UE or along DL-RS. Such an LOS indicator may be associated with a TRP or a Positioning Reference Signal (‘PRS’) resource ID, which may for example be an index. The UE may receive the LOS indicator from the network per TRP or resource ID. In some cases, the UE may determine the LOS indicator per TRP or resource ID based on measurements.

A UE location may be expressed in terms of altitude, latitude, geographic coordinate, or local coordinate, for example.

In the examples described herein, a timestamp be indicated by absolute time, relative time (e.g., in seconds) compared to a reference time, a system frame number (‘SFN’), a slot index, a frame index, a subframe index and/or a symbol index. Examples of “absolute time” may be coordinated universal time (‘UTC’) time, global navigation satellite system (‘GNSS’) time, and/or locally defined absolute time which may for example be LTE or New Radio (‘NR’) Time.

In an example scenario, the UE may receive DL-RS and/or UL-RS, for example SRS configurations for positioning purposes from the network, for example the LMF. The LMF may forward the PRS configuration and SRS configurations to the gNB such that the gNB may schedule PRS transmission or SRS reception at the TRP, the transmit point (‘TP’) and/or the receive point (‘RP’).

In some cases, a DL-RS configuration may contain at least one of the following parameters: a number of symbols, a transmission power, a number of DL-RS resources included in DL-RS resource set, a muting pattern for DL-RS which may, for example, be expressed via a bitmap, a periodicity, a type of DL-RS which may, for example, be periodic, semi-persistent, or aperiodic, a slot offset for periodic transmission for DL-RS, a vertical shift of DL-RS pattern in the frequency domain, a time gap during repetition, a repetition factor, a resource element (‘RE’) offset, a comb pattern, a comb size, and/or a spatial relation, for example with respect to other DL-RSs or UL RS such as SRS for positioning purpose.

In some cases, a DL-RS configuration may contain at least one of the previous parameters and/or at least one of the following parameters: Quasi Co-Location (‘QCL’) information, for example a QCL target and/or QCL source for DL-RS, a number of TRPs, an Absolute Radio-Frequency Channel Number (‘ARFCN’) subcarrier spacing, an expected Reference Signal Time Difference (‘RSTD’), an uncertainty in expected RSTD, a start Physical Resource Block (‘PRB’), bandwidth, a bandwidth part (‘BWP’) ID, a number of frequency layers, a start/end time for DL-RS transmission, an on/off indicator for DL-RS, a TRP ID, a DL-RS ID, a cell ID, a global cell ID and/or an applicable time window.

The UE may apply a DL-RS configuration under a condition that the current time is within the applicable time window. As set out earlier, the term “ID” may be used interchangeably with “index”.

Examples of a DL-RS may include a CSI-RS, a Phase Tracking Reference Signal (‘PTRS’), a PRS, a TRS, and/or a Synchronization Signal Block (‘SSB’).

In some cases, an UL-RS or SRS configuration may include at least one of: a resource ID; comb offset values; cyclic shift values; a start position in the frequency domain; a number of UL-RS symbols; a shift in the frequency domain for UL-RS; a frequency hopping pattern; a type of UL-RS, for example aperiodic, semi-persistent, and/or periodic. In some cases, an UL-RS or SRS configuration may include at least one of: a sequence ID used to generate an UL-RS or other IDs used to generate UL-RS sequence; and/or spatial relation information which may, for example indicate which reference signal, for example DL-RS, UL-RS, CSI-RS, SRS, DM-RS, or SSB, for example an SSB ID, cell ID of the SSB, the UL-RS is related to spatially and where the UL-RS and DL-RS may be aligned spatially.

In some cases, an UL-RS or SRS configuration may contain at least one of the previous parameters and/or at least one of the following parameters: QCL information, for example a QCL relationship between UL-RS and other reference signals or SSB; a QCL type, for example QCL type A, QCL type B, QCL type C, and/or QCL type D; a resource set ID; a list of UL-RS resources in the resource set; transmission power related information; pathloss reference information which may contain index for SSB, CSI-RS or DL-RS; a periodicity of UL-RS transmission; and/or spatial information such as spatial direction information of UL-RS transmission, for example beam information, angles of transmission, and/or spatial direction information of DL-RS reception which may, for example be a beam ID used to receive DL-RS, angle of arrival. As set out earlier herein, the term “ID” may be used interchangeably with “index”.

In some cases, a “DL positioning method” may refer to any positioning method that uses downlink reference signals such as PRS. In such cases, the UE may receive multiple reference signals from TP(s) and may measure a Downlink Reference Signal Time Difference (‘DL-RSTD’) and/or RSRP. Examples of DL positioning methods include Downlink Angle of Departure (‘DL-AoD’) and/or Downlink Time Difference of Arrival (‘DL-TDOA’) positioning.

In some cases, an “UL positioning method” may refer to any positioning method that uses uplink reference signals such as SRS for positioning. In such cases, the UE may transmit an SRS to multiple RPs and the RPs may measure the Uplink Relative Time of Arrival (‘UL-RTOA’) and/or RSRP. Examples of UL positioning methods include Uplink Time Difference of Arrival (′UL-TDOA′) and/or Uplink Angle of Arrival (‘UL-AoA’) positioning.

In some cases, the phrase “DL & UL positioning method” may refer to any positioning method that uses both uplink and downlink reference signals for positioning. In some examples, a UE may transmit SRS to multiple TRPs and a gNB may measure Rx-Tx time difference which may be calculated based on the time of arrival of DL-RS, for example a PRS. The gNB may measure a RSRP for the received SRS. The UE may measure a Rx-Tx time difference for the PRS transmitted from multiple TRPs. The UE may measure a RSRP for the received PRS. The Rx-TX difference and, in some cases, a RSRP, is measured at the UE and the gNB and may be used to compute round trip time In such examples, the phrase “UE Rx-Tx time difference” may refer to the difference between an arrival time of the reference signal transmitted by the TRP and a transmission time of the reference signal transmitted from the UE. One such example of a DL & UL positioning method is multi-Round Trip Time (‘RTT’) positioning.

One example of measurement may be a Channel Impulse Response (‘CIR’). A channel impulse response, consisting of N paths, may be defined by the equation

$$h ( t ) = {\sum }_{k = 1}^{N} {h}_{k} ( t ) δ ( t - {τ}_{k} )$$

where hₖ(t) and τₖ are time-varying complex valued coefficients which may, for example be expressed by a+bj where j=\sqrt{−1} for the channel impulse response and delay, measured in seconds, for the k^{th} path, respectively. The delta function may be defined as δ(t)=1 for t=0 and δ(t)=0 for t≠0.

For simplicity, it may be assumed that the coefficients are constant over time, for example hₖ(t)=hₖ. In some cases, the UE may report hₖ and τₖ for each path k to the network. In some cases, the UE may report the number of paths, N, to the network. In other cases, the UE may receive hₖ and τₖ for each path k from the network and/or the number of paths.

In another example, the UE may obtain a Channel Impulse Response (‘CIR’) from the network. The network may indicate a DL-RS configuration and/or configurations such as a DL-RS resource ID and/or IDs associated with the CIR. In some cases, the CIR may be associated with a DL-RS resource ID. In this example, the UE may determine that the CIR is derived based on the measurements made on the DL-RS resource associated with the ID. Alternatively, the UE may determine that the channel along the direction of transmission of the DL-RS or reception of the DL-RS corresponds to the CIR.

In another example, the CIR may be associated with a TRP ID. In this case, the UE may determine that the CIR represents the channel between the associated TRP and the UE. In a yet further example, the CIR may be associated with more than one TRPs where the network may include TRP indices associated with the CIR.

In some cases, the CIR may be associated with a cell. In such cases, the UE may receive a cell ID or index associated with the CIR from the network. In some cases, the CIR may be associated with more than one TRPs or DL-RS resource IDs. In such cases, the UE may determine that the channel between the TRPs and the UE corresponds to the CIR. Alternatively, the UE may determine that the channel along the transmission directions of DL-RSs associated with IDs or reception directions of the DL-RS correspond to the CIR.

In a further example, more than one CIRs may be associated with one parameter from DL-RS configurations which may, for example, be a TRP ID, a DL-RS resource ID, and/or a frequency layer ID. The UE may receive information related to 2 CIRs associated with a TRP from the network, for example

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} ) .$$

In some cases, the UE may report information related to more than one CIRs associated with DL-RS configuration (e.g., TRP ID, DL-RS resource ID) based on the measurements to the network. There may be more than one CIRs associated with DL-RS configuration since the UE or network may observe different channel characteristics based on an Angle of arrival (‘AoA’) of DL RS or UL RS, for example.

Channel impulse response may be represented by delay profile (‘DP’) or power delay profile (‘PDP’). A power delay profile may be defined as a set of delays and power profiles, such as [τ₀, τ₁, . . . , τ_{N-1}] and [p₀, p₁, . . . , p_{N-1}], where pₖ may correspond to relative power at the k^{th} path compared to the first path. A delay profile may be defined as a set of delays [τ₀, τ₁, . . . , τ_{N-1}] which indicates path delay for each path above p_{threshold}. The UE may receive p_{threshold} from the network to derive delay profile from power delay profile.

In an example, the UE may receive an indication from the network which describes how to generate a CIR, a PDP or a DP based on timing, phase and/or power measurements. The UE may send a request to the network to receive an indication on which methodologies to use to generate the CIR, the PDP or the DP based on the measurements the UE made. The UE may receive a message from the network, for example via LPP, RRC, MAC-CE, and/or Downlink Control Information (‘DCI’) which may indicate the DL-RS resource indices and associated measurement type or types, for example RSTD, AOA to use to generate the CIR, the PDP or the DP. In some cases, the UE may receive an indication from the network indicating to generate CIR, PDP or DP.

In some cases, the UE may receive a threshold, for example a power threshold, from the network and a timing range, for example 0 μs to 1 μs, a timing granularity, for example every 0.1 μs in the indicated timing range, and/or 100 sample points in the indicated timing range of the CIR, the PDP and/or the DP. In such a scenario, the UE may make a determination to report power and timing, for example relative timing compared to a reference timing, absolute timing of any samples whose received power is over the threshold.

The UE may send measurements in a report to the network, for example the LMF and/or the gNB via a semi-static message, for example an LPP and/or an RRC message, or a dynamic message, for example an UCI, and/or an UL MAC-CE message.

As described herein, the terms DL-RS and, for example CSI-RS, DM-RS, TRS and/or SSB may be used interchangeably.

During sensing, a UE may observe multiple paths in the received signal where some of the paths may correspond to the reflected signal against the target of interest. The UE may make a determination to estimate the location of a target and/or a velocity of the target. In some cases, the UE may make a determination to make measurements which may assist the network to determine the location of a target and/or a velocity of the target.

A shift or change in the measured frequency may be caused by the movement of the target. To estimate the target's velocity, the UE or network may estimate the associated Doppler frequency. Doppler shift may introduce a phase rotation in the signal over a time period and doppler shift may be determined by observing a change in phase of received signals over a time.

The doppler shift of a target may be observed through a path or paths through the use of Channel Impulse Response (‘CIR’).

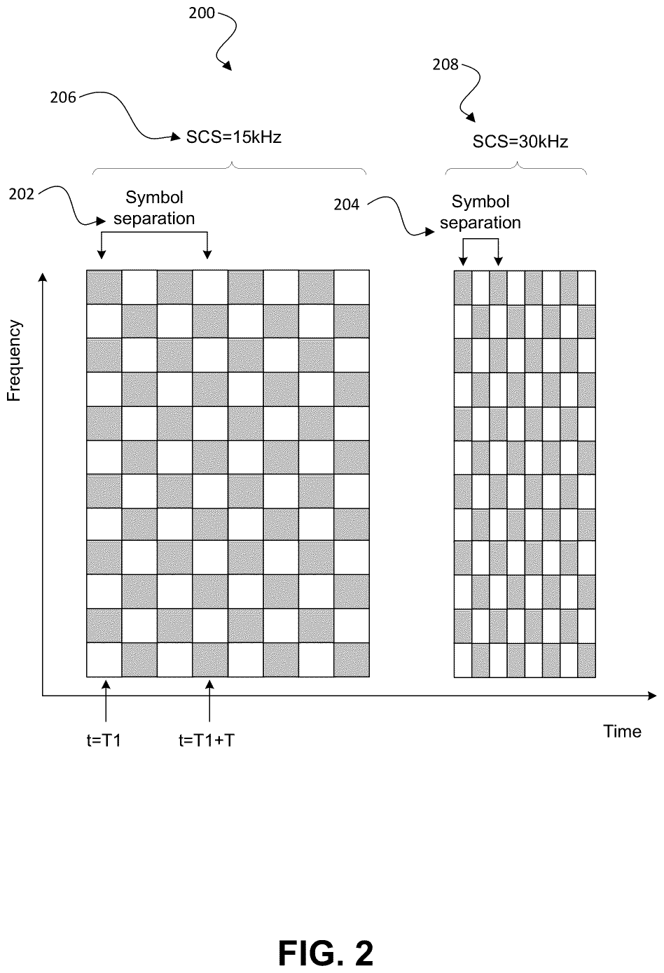

FIG. 2 shows an example of symbol separation and Subcarrier spacing (‘SCS’), and a corresponding time span for OFDM symbols with DL-RS. FIG. 2 shows a first symbol separation 202 and a second symbol separation 204. The first symbol separation 202 is at a first SCS 206 and the second symbol separation 204 is at a second SCS 208. In the example shown in FIG. 2, the first SCS 206 is 15 kHz and the second SCS 208 is 30 kHz. As can be seen in the frequency and time diagram 200 of FIG. 2, subcarrier spacing (‘SCS’) and temporal separation between two RS OFDM symbols may be used to determine resolvable Doppler shift. As described earlier herein, a small SCS, for example 15 kHz which corresponds to the first SCS 206, or a large temporal separation between two Reference Signal (‘RS’) OFDM symbols may lead to a coarse granularity of phase measurement, which may be used for low movement or mobility or a small Doppler shift.

A large SCS, for example 60 kHz, or a small temporal separation between two RS OFDM symbols may lead to a fine granularity of phase measurement, which may be used for large movement or high mobility, or a large Doppler shift.

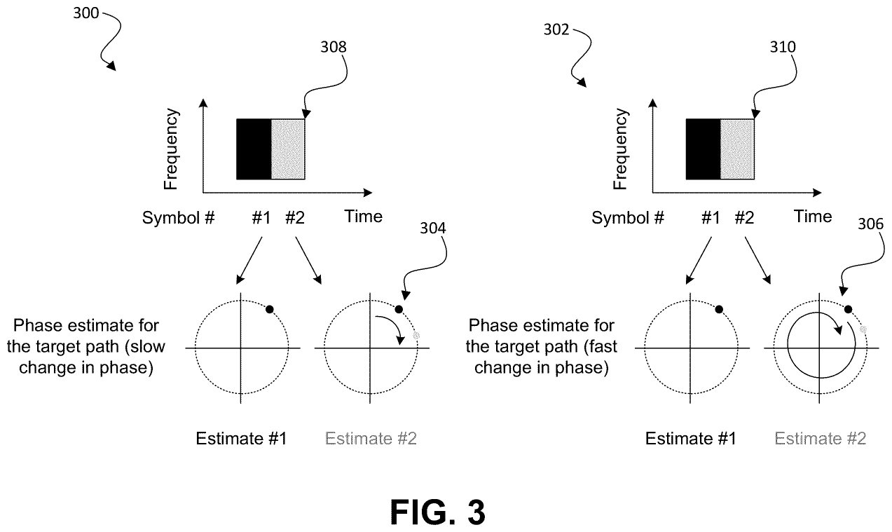

FIG. 3 shows an example of phase estimate for a path corresponding to a target which illustrates phase-wrap-around due to fast mobility of a target. The leftmost diagram 300 of FIG. 3 includes a frequency and time diagram and corresponding phase estimates for a slow change in phase. The rightmost diagram 302 of FIG. 3 includes a frequency and time diagram and corresponding phase estimates for a fast change in phase. As shown in the leftmost diagram 300 and the rightmost diagram 302 of FIG. 3, the phase of the path corresponding to the target in the CIR may be tracked. In the leftmost diagram 300, symbol 308 may have a small phase shift estimate 304, because a target object may be moving slowly, giving a slow change in phase. In the rightmost diagram 302, symbol 310 may have a large phase change estimate 306 which may “wrap around” as a characteristic of the wrap-around nature of phase. It may be possible to estimate the Doppler shift caused by the target's movement by measuring the change in phase of the path over a time period.

That which is shown in FIG. 3 may occur at a UE, which may be a WTRU 102a, 102b, 102c of FIG. 1B. More generally, references to a UE in the following description and in the following Figs may be a WTRU 102a, 102b, 102c of FIGS. 1B, 1C, and/or 1D. References to a network may be a core network 106, a core network 115, and may include an AMF 182a, 182b, an SMF 183a, 183b, a UPF 184a, 184b, and/or a DN 185a, 185b.

When the target is moving, the UE or network may not know the speed or velocity of the target. In turn, the UE may therefore not be able to estimate a Doppler frequency shift or change in phase caused by the target movement accurately. This may arise because of the wrap-around nature of phase as demonstrated by large phase change estimate 306. In other words, because of the Doppler shift, if phase changes quickly between OFDM symbols, as shown in the diagram 302 and by large phase change estimate 306, the phase may wrap around.

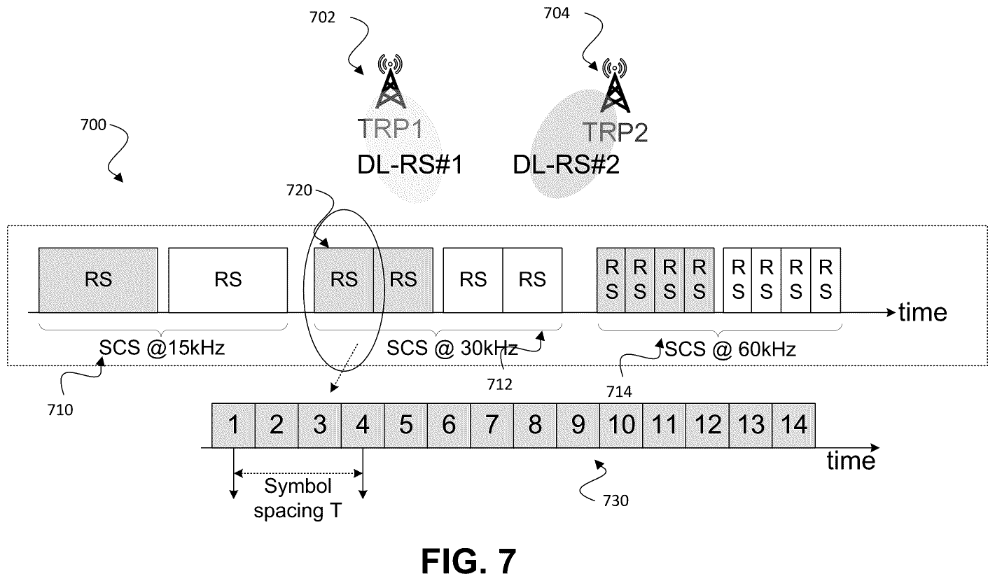

In some examples, a UE may be configured with DL-RSs each associated with different SCSs, which may, for example be SCSs of 15 kHz, 30 kHz, and/or 60 kHz. Exemplary SCSs are shown in FIG. 7 and are discussed later herein. The UE may be configured with an expected Doppler frequency, for example a coarse granularity, and a range of the target.

In an example, based on an expected or estimated Doppler frequency, the may UE determine the SCS of a Received Signal (‘RS’) on which to make measurements. These measurements may, for example, include a differential phase at a given path at different OFDM symbol timing and/or AoA. The UE may make a measurement or measurements on a DL-RS at the configured order of SCS This may, for example, start from the highest SCS configured. The UE may then make measurements on the second highest SCS configured. If the UE is not configured with an expected Doppler frequency, the UE may measure RSs across all SCSs and report the measurements to the network.

A UE may be configured with a consistency condition which may define a consistency window, and if a consistency condition is broken during the configured consistency window, the UE may send a request for reconfiguration of DL-RSs. The consistency window may be a time period, and the time period may be measured in terms of seconds, frames, or the like. The time period which may form the consistency window may be taken as being a duration in time, and may be defined in terms of a duration, by a start and/or end time, or similar.

In some cases, an expected Doppler configured by the network may not be precise. In some cases, the UE is able to estimate, without specific input, the Doppler frequency based on the expected Doppler frequency. In some cases, the UE may choose an appropriate configuration.

In an example, a UE may receive a request to report its location. The UE may report its location, and the location reported may be determined by a RAT-dependent or RAT-independent positioning method as described herein to the network. The UE may also receive a request for consistency. As part of the request for consistency, the UE may receive a configuration of a consistency window which may, for example, include a start time, an end time, and/or a duration.

The UE may be configured, for example via broadcast, with the first set of DL-RSs, and where each DL-RS is associated with an SCS. The UE may be configured with more than one SCS. The UE may carry out measurements on the first set of DL-RSs and may then report measurements for the first set of DL-RSs.

The may UE receive an indication of the set of DL-RSs on which to make measurements. This set of DL-RSs may, for example, be a second set of DL-RSs which may be a subset of the first set of DL-RSs. In some cases, the network may determine the set of DL-RSs based on the location of the UE.

If the UE is configured with the expected Doppler estimate, the UE may determine the SCS and corresponding DL-RS and OFDM symbol indices on which to make measurements. This may include temporal separation between two OFDM symbols. If the determined Doppler shift is below a threshold and/or a standard deviation of an RSRP for a target path is above a threshold, the UE may determine to average the measured phase measurements.

In some cases, the UE may not be configured with an estimate of the expected Doppler frequency, and in such a case, the UE may make a determination to make measurements on all of the configured DL-RSs.

The UE may report measurements, which may for example include CIR, on the determined SCS and may report them to the network. The UE may indicates which SCS was used to derive the measurement or measurements if the expected Doppler frequency is configured. The UE may also indicate whether the reported phase measurement is averaged or not. If the estimated Doppler frequency is different from the expected Doppler frequency or if the estimated Doppler frequency is a range, the UE may report the estimated Doppler frequency.

If a configured consistency condition is violated during the consistency window, for example the UE rotates or moves, the UE may report the cause, and may also request reconfiguration of the DL-RSs for measurement.

The UE may receive DL-RSs with more than one subcarrier spacing (‘SCSs’). The UE may make a determination of the SCS to measure based on the expected or estimated Doppler frequency. If a consistency condition is broken, for example the UE rotates or moves during a configured consistency window, the UE may make a request for DL-RS reconfiguration, for example the network may search for a DL-RS that contains a LOS path.

The UE may be pre-configured with line of sight (‘LOS’) DL-RSs such that the corresponding measurement contains a LOS path with validity conditions. The UE may also receive a configuration for a consistency window. As described above, the consistency window may be a time period which may be defined as a period of time for which compliance by the UE with any consistency parameters may be desired. The time period may be, for example, a period measured in nanoseconds, milliseconds, seconds, frames, symbols, or similar.

If the UE breaks a consistency condition during a consistency window, or if a validity condition is not satisfied, the UE may make a request for measurement on DL-RSs for LOS determination.

In one example, which may be broadcast-based DL-RS, the UE may determine or select which reference signal (‘RS’) to measure based on an expected Doppler frequency estimate from the network.

In such an example, the UE may be configured with downlink reference signals (‘DL-RSs’) with different sub carrier spacings (‘SCSs’). These subcarrier spacings may, for example, be 15 kHz, 30 kHz, and/or 60 kHz. An example of such subcarrier spacings is shown in FIG. 7 and will be discussed later. The UE may be configured with an expected Doppler frequency of the target. Based on the expected or estimated Doppler frequency, the UE may determine the SCS of RS to make measurements. The measurements may include a measurement or measurements of a differential phase at a given path at different OFDM symbol timing. If the UE is not configured with an expected Doppler frequency, the UE may measure RSs across all SCSs and may report measurements to the network. If a consistency condition is broken during the configured consistency window, the UE may send a request for reconfiguration of DL-RS.

In another example, which may include on-demand based reconfiguration with estimated range of Doppler shift, the UE may report differential measurements on the default SCS. The UE may determine a range of Doppler shifts based on the measurement. The UE may make a request, along with the estimated range of Doppler shift, to the network suggested SCS on which to make measurements.

In a further example, in which the UE may report measurement to the network with a configuration and, in response, the UE may be reconfigured, the UE may report differential measurements at a configured symbol spacing (e.g., every symbol, every other symbol) at the default SCS. The UE may receive an indication, from the network, on which SCS to make measurements. In this example, the UE may make measurements at the configured SCS and may then return to the default SCS for measurements.

In some cases, the UE may receive, from the network which may, for example be a gNB and/or an LMF, configurations regarding the DL-RSs (Downlink Reference Signals) the on which the UE may make measurements. The UE may make a determination to make measurements for the purpose of sensing. As described herein, the term “sensing” may be used interchangeably with the terms “positioning”, “measurement” or “communication”. In some examples, the UE may be configured to make measurements on indicated DL-RSs and report types of measurements described herein to the network.

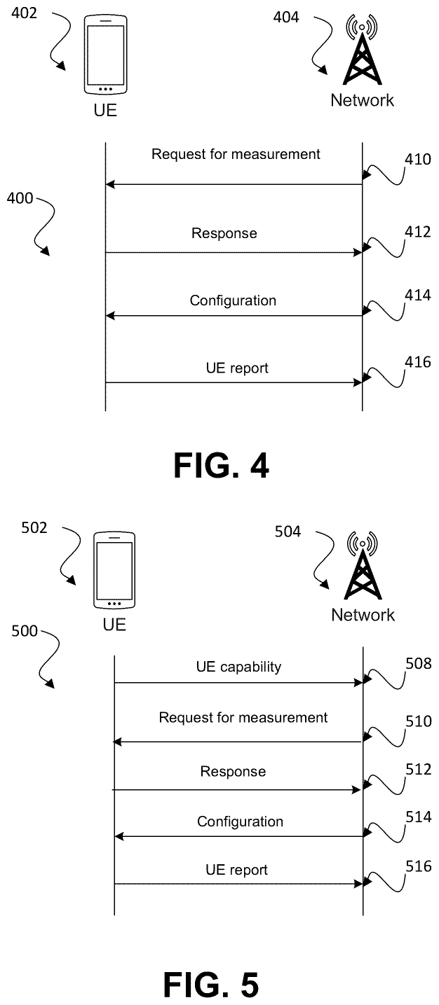

FIG. 4 shows an exemplary signaling diagram illustrating a request for sensing and response from a UE. The UE 402 may make a determination to make measurements on the DL-RS for sensing purposes. As can be seen in the signaling diagram 400 of FIG. 4, interactions may occur between the network 404 and UE 402 for initiating sensing. In the example shown in FIG. 4, at step 410 the UE 402 may receive, from the network 404, a request for sensing or making measurements on indicated DL-RSs in the request. The UE 402 may receive the request 410 in broadcast which may for example be SIB, multi-cast or unicast in a higher layer message type such as LPP and/or RRC, MAC-CE or a lower-layer message which may for example be a DCI message. The UE 402 may, at step 412, send a response, which may for example be an Acknowledgement (‘ACK’) or Negative Acknowledgement (‘NACK’) message to accept or deny the request, or may respond based upon UE capabilities to the network 404. If the UE 402 makes a determination to accept the request, at step 414 the UE 402 may receive at least one configuration of DL-RSs from the network 404. At step 416, the UE may make a determination to make a measurement report if a trigger condition or conditions for the measurement reporting are met or satisfied and may send the report.

FIG. 5 shows an exemplary signaling diagram illustrating UE capability reporting, request for sensing and response at the UE. That which is shown in the signaling diagram 500 of FIG. 5 is another example of obtaining the DL-RS configuration for sensing. In the example shown in FIG. 5, at step 508 the UE 502 may make a determination to send a UE 502 capability report to the network 504 based on a request from the network 504 or as part of an initial access procedure.

The UE 502 capability report may include at least one of the following. The UE 502 may report whether the UE 502 is stationary or mobile device. An example of stationary device is a device that is plugged into an electric outlet. An example of a mobile device may be a handset, or a device that is attached to a mobile object such as a car or drone. The UE 502 may report its capability to make measurements on specific types of DL-RSs, which may, for example, be SSB, CSI-RS, DM-RS, PRS, TRS, and/or PTRS.

The UE 502 may report its capability to make measurements periodically and capable periodicity, for example Ims. The UE 502 may report its capability to report to the network 504 periodically and the relevant capable periodicity, for example Ims. The UE 502 may report its capability to perform measurements and its capability to send reports that contain the measurements.

The UE 502 may report its capability to perform sensing-related measurements and sending reports that contain sensing related measurements, and/or its capability to perform sensing and communication. The UE may report location information and the method used to determine the UE location information, which may for example be RAT-dependent, RAT-independent, determined based on GNSS, or the like. The UE 504 may report its supported sensing types, wherein sensing type may include one or more of: sensing accuracy, for example maximum or minimum accuracy, measurement granularity; a use case, for example detection, tracking, or the like; a sensing measurement with and/or without UE 504 positioning information; a number of sensing measurement resources which the UE 504 may perform simultaneously; support for simultaneous sensing measurement and communication at the same and/or different frequencies.

After sending the UE 504 capability report, at step 510 and similar to step 410 described above, the UE 504 may receive a request for sensing from the network. At step 512, similar to step 412 above, the UE may send a response to the request to the network. If the UE accepts the request, at step 514, similar to step 414 above, the UE may receive configurations for the on which DL-RS to make measurements. At step 516, similar to step 416 above, the UE may make a determination to make a measurement report if a trigger condition or conditions for the measurement reporting are satisfied and may send the report.

In one example, the UE may receive a request from the network, for example a gNB and/or an LMF to report the UE location. In an example, the UE may report its location using a RAT-independent positioning method, for example GNSS) and/or a RAT-dependent positioning method, for example downlink time difference of arrival (‘DL-TDOA’). The UE may indicate to the network the positioning method used to determine the UE location. The UE may receive the request for UE location before the UE reports sensing related measurements to the network. The UE may report the UE location after the UE receives a request to perform sensing related measurements.

As described herein, the term “measurements” and the phrase “sensing related measurements” may be used interchangeably.

The UE may receive a configuration or configurations of the DL-RS from the network via broadcast, multi-cast or unicast. The configuration or configurations of the DL-RS may include the parameters for reference signals described herein. For example, such a parameter or parameters may be periodicity of the DL-RS; frequency information, for example ARFCN, frequency range, and/or range of frequency; sequence information of the DL-RS, for exampling a scrambling ID; transmission power level; and/or time/frequency pattern/density of the DL-RS.

In an example, the range of frequency may be expressed in terms of bandwidth parts (‘BWP’); lower and higher frequency values, for example in terms of Hertz; a number, for example at least one resource block identifier or number, resource element number or identifier; and/or an indicator, for example an indicator associated with a range of frequency resources.

In some cases, the UE may be configured with the time-domain parameters of the DL-RSs. For example, the UE may be configured with the number of slots, symbols or frames that contain the DL-RSs on which the UE may make measurements.

In some cases, the UE may receive an indication for a search space for DL-RSs. For example, the UE may be configured with time and frequency resources which the UE is expected to monitor for a potential presence of the DL-RS. The UE may determine that the DL-RS exists in the indicated time and frequency resources, and if the UE makes such a determination, the UE may make a determination to make measurements on the DL-RS. The aforementioned time and frequency resources may occur periodically; semi-persistently, for example periodically during a time window, and/or periodically occurring time and frequency resources may be activated and/or deactivated by MAC-CE.

In some cases, the UE may receive a request to receive and decode a downlink channel, for example a PDCCH and/or a Physical Downlink Shared Channel (‘PDSCH’) and may determine the location of the DL-RS to measure. The downlink channel may contain information about the time and frequency resources of the DL-RS the UE is to measure.

In an example, a UE may determine a sequence of DL-RSs for a sensing measurement, wherein the sequence may be determined based on at least one of: a sensing use case, for example detection and/or tracking; a geographical location of the target or the UE; a desired sensing measurement accuracy level; a physical cell ID or TRP ID associated for the sensing; and/or UE-ID. Such a sequence may include one or more of: a sequence type, for example a Gold-sequence, an m-sequence, a Zadoff-Chu or the like; a sequence initialization ID; a scrambling ID; a cyclic shift index; a root-index; and/or any parameter which may determine the sequence.

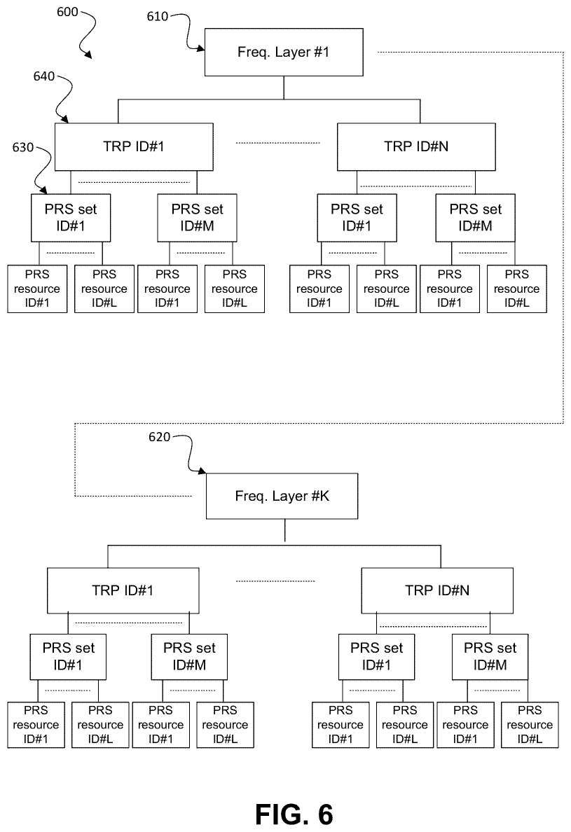

FIG. 6 shows an exemplary hierarchical structure 600 of PRS configurations. In the example shown in FIG. 6, the UE may be able to determine parameters for PRS resources based on the associated PRS set in the hierarchy. For example, if PRS set #1 630 is configured with N repetitions, the PRS resources associated with the PRS set #1 may also be configured with N repetitions. Similarly, PRS sets or PRS resources that are associated with a TRP, for example TRP ID #1 640 may have the same configuration. For example, if TRP ID #1 640 is configured to transmit DL-RS generated with a random sequence based on sequence ID #1, the UE may assume that DL-RSs associated with TRP ID #1 640 are also generated based on the random sequence generated based on the sequence ID #1.

As illustrated in FIG. 6, if frequency layer is higher in the configuration hierarchy, any information associated with the frequency layer may be applicable for the parameters that are associated with the hierarchy. Therefore, if an SCS value is associated with Frequency Layer index #1 610, the UE may determine that any PRS resources under the Frequency Layer index #1 follow the same SCS. The same may be true of Frequency Layer index #K 620.

FIG. 7 shows an example of different side channel spacings over time for two reference signals. Three side channel spacings 710, 712, 714 are shown in FIG. 7. In the example shown in FIG. 7, the first side channel spacing 710 is at 15 kHz, the second side channel spacing 712 is at 30 KHz, and the third side channel spacing 714 is at 60 kHz. In the example time and frequency diagram 700 shown in FIG. 7, the UE may receive an explicit configuration of an SCS associated with a DL-RS configuration parameter, for example a DL-RS resource ID. In some cases, the UE may be configured with DL-RSs with associated SCSs. As shown in FIG. 7, a DL-RS resource may be associated with an SCS. A particular RS 720 at the second side channel spacing 712 at an SCS of 30 kHz is reproduced along a time axis in subdiagram 730 which shows the symbols of the RS. The symbols may have spacing T. The UE may receive, from the network, for example a gNB and/or an LMF, configuration for repetition of a DL-RS with the same SCS. Referring to the example shown in FIG. 7, DL-RS resource #1 702 and DL-RS resource #2 704 may be associated with SCS of 15 kHz and 30 kHz respectively. Each resource may repeat in the time domain at configured number of repetitions, N, for example. In the example illustrated in FIG. 7, TRP #1 transmits PRS #1 with SCS at 30 kHz with a repetition factor N=2. In the same example, TRP #1 transmits PRS #1 with SCS at 60 kHz at a repetition factor N=4.

In some cases, the UE may receive configurations for SCS and DL-RS via higher layer message, for example by RRC and/or LPP by broadcast, groupcast or unicast message. In some cases, the UE may determine an SCS for the DL-RS if SCS is associated with a DL-RS configuration parameter that is higher than the DL-RS resource in the hierarchy of the configuration.

A repetition factor may be separately configured for each SCS value. For example, SCS at 15 kHz may have a different repetition factor compared to SCS at 60 kHz. In an example, the UE may receive more than one DL-RSs at the same SCS. The DL-RSs may be multiplexed in the time domain, frequency domain or spatial domain.

In the example illustrated in FIG. 7, the UE may receive DL-RS #1 702 and DL-RS #2 704 from TRP1 and TRP2, respectively, where DL-RS #1 702 and DL-RS #2 704 are multiplexed in the time domain.

In some cases, the UE may receive DL-RSs from one TRP. The UE may receive a TRP ID or IDs from which the DL-RSs are transmitted. Each TRP may be associated with different SCS. The UE may determine the SCS based on the configured TRP ID. The UE may determine the TRP on which to make measurements based on the determined SCS to measure.

In some cases, the UE may be configured with more than one time windows where each window is associated with an SCS. For example, if the UE is configured with 2 time windows, the first and second time window may correspond to SCS of 15 kHz and 30 kHz, respectively. Thus, if the UE is configured to receive a DL-RS during a window, the UE may determine SCS based on the configured window.

In some cases, the UE may be configured with a pattern of SCSs that the UE may receive. For example, the UE may be configured with an SCS value configured per DL-RS configuration parameter such as a DL-RS ID, a DL-RS resource ID, a DL RS resource set ID, and/or a component carrier ID or the like. The UE may receive a pattern of SCS values or configuration parameters that the UE is expected to receive. For example, as illustrated in FIG. 7, the UE may receive [15 30 60] from the network, indicating that the UE will receive DL-RS at SCS of 15 kHz, 30 KHz and 60 KHz.

In one example, an SCS may be associated with a frequency resource, for example a BWP, a band, a bandwidth, a carrier, and/or a carrier component. The UE may make a determination switch BWP to receive the DL-RS at the associated SCS. For example, each frequency resource, for example a BWP, not overlapping in the frequency domain, may be associated with an SCS. If the UE receives a request to make measurements on a specific SCS, the UE may make a determination to switch to the corresponding frequency resource, for example BWP.

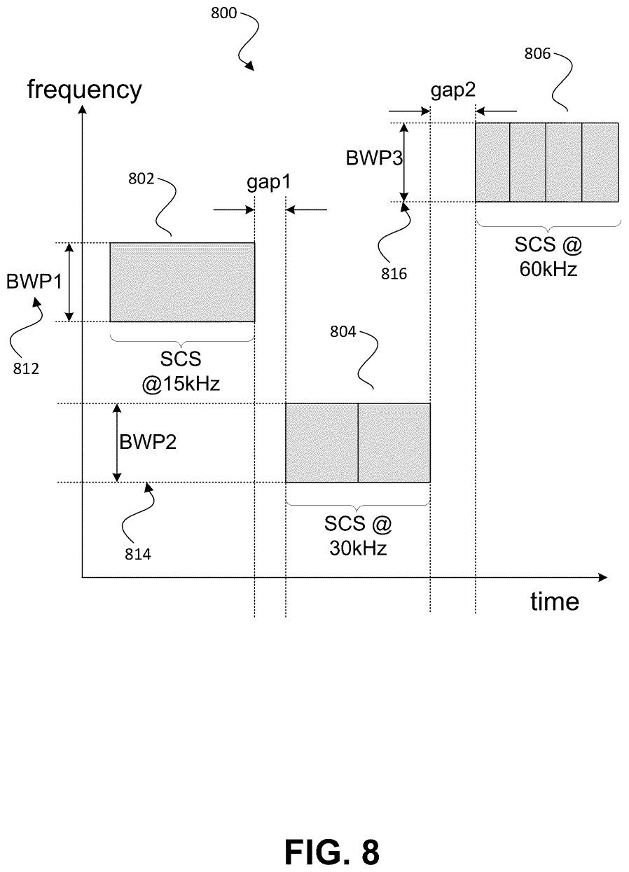

FIG. 8 shows an example of a relationship between bandwidth parts and side channel spacings. In the time and frequency diagram 800 shown in FIG. 8, three representations of symbols at three SCSs 802, 804, and 806 are shown, and three bandwidth parts (‘BWPs’) 812, 814, 816 are associated with each SCS value. For example, BWP1 812, BWP2 814 and BWP3 816 are associated with a first SCS 802 of 15 kHz, a second SCS 804 of 30 kHz, and a third SCS 806 of 60 kHz, respectively. Between each BWP, there may be a gap or period which may allow the UE or NW to change BWP. These gaps are denoted in FIG. 8 as gap1 and gap2.

In some cases, the UE may determine the SCS to measure based on at least one or combination of the following: an expected Doppler frequency of the target provided by the network in assistance information; a range of expected Doppler frequencies of the target provided by the network in assistance information; and/or an estimated Doppler frequency of the target based on the measurements made by the UE.

In some cases, the UE may receive expected Doppler frequency or range of expected Doppler frequency from the network based on which the UE may make a determination of the DL-RS to receive, along with a corresponding SCS. For example if the expected Doppler frequency is a low value, the UE may determine to make measurements on the DL-RS at low value of SCS, for example 15 kHz. However, if the expected Doppler frequency is a high value, the UE may determine to make measurements on the DL-RS at a high value of SCS, for example 60 KHz.

In some cases, the UE may make a determination to choose more than one SCS for measurements. In such a case, the UE may determine which DL-RSs to measure, based on the determined SCSs.

In some cases, the UE may make a determination of the estimated Doppler frequency based on an expected Doppler frequency or range of expected Doppler frequencies. In such a case, the UE may determine the SCS or SCSs to measure based on the estimated Doppler frequency. The UE may report, in addition to the measurements, which may for example include the phase, the estimated Doppler frequency. In some cases, the UE may report to the network how the UE determined or estimated the Doppler frequency. For example, the UE may report the method used to estimate the Doppler frequency, and this method may, for example, be based on measurements and/or data from sensors at the UE, and/or may be based on RAT-independent methods.

In some cases, the UE may receive an expected target velocity and/or a range of expected target velocities. Based on such velocity information, the UE may make a determination of the SCS to be used for the measurement. The UE may make an estimate of the target velocity based on an expected target velocity or range of expected target velocities.

In some cases, the UE may receive an expected absolute or relative location of the target. If the UE is provided with the relative location of the target, the UE may also receive the reference location of the target. In some cases, the UE may receive a direction of the movement, for example north or south of the target. The UE may report, in addition to the measurements, an estimated location of the target and/or estimated direction of the movement of the target.

The UE may be configured with a time window with which an expected Doppler frequency, an expected velocity, and/or a range of Doppler frequencies is associated with. The UE may be configured with more than one time window, with each associated with the same or a different expected Doppler frequency. Each time window may be associated with an index. Each window may have start time and/or end time, a duration, and and/or a periodicity associated therewith. The UE may be configured with more than one time windows, in cases where the network may expect that the target may move at a different speed during different time intervals.

In some cases, the UE may receive, from the network, for example via RRC, LPP, MAC-CE, and/or DCI, a sequence of the indices of time windows, each of which may be associated with a Doppler frequency. During the time window, the UE may expect the target to move at a velocity corresponding to the Doppler frequency. In some cases, the UE may receive an activation or a deactivation command, for example via MAC-CE, which may include the window index. The UE may receive a trigger, for example via DCI, to make a measurement or measurements on the Doppler frequency, and the trigger command may include the window index.

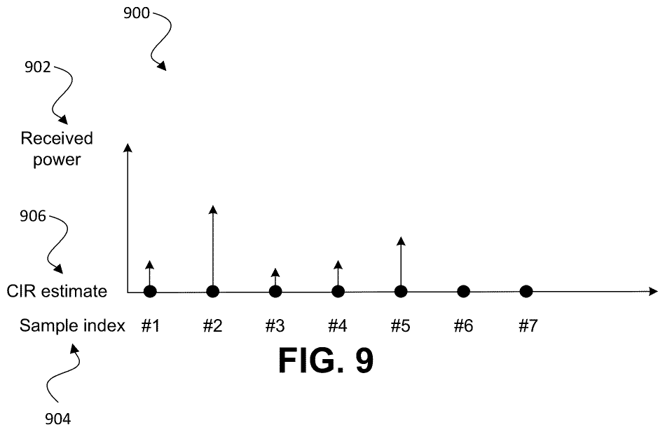

FIG. 9 shows an example of channel impulse response (‘CIR’) estimates. In some cases, example, the UE may obtain a CIR estimate for the received OFDM symbol. In the chart 900 shown in FIG. 9, chart 900 shows received power 902, a sample index 904, and a CIR estimate 906 for each sample, and the CIR estimate 906 consists a CIR for 7 samples. The CIR estimate 906 may contain more or fewer than 7 samples. The UE may receive, from the network, the number of samples for CIR estimates 906. The UE may report measurements, for example phase, or per sample if a measurement corresponding to the sample, for example RSRP, is above the configured threshold.

The UE may receive a request to report CIR from the network. In this case, the UE may report a sample or samples whose measurement is above a threshold, for example RSRP. The UE may indicate measurements, for example power and/or phase and relative timing of the sample with respect to a reference timing. The UE may report the OFDM symbol index at which the CIR is obtained. In addition, the slot index, frame index, subframe index and/or the SFN which includes the OFDM symbol may be reported. The UE may make a determination to report an average of the CIR estimates. In this case, the UE may report to the network the number of OFDM symbols used.to determine the average. In addition, the UE may report location of the OFDM symbols, for example the symbol index, slot index, frame index, subframe index, and/or the SFN used to derive the average CIR.

In some cases, the UE may receive a request to report N estimates of the CIR within a configured duration, for example one slot. In this case, the UE may estimate CIR per OFDM in the configured duration but the UE may make a determination to report N of them based on a criterion, for example the N number of highest RSRPs.

In addition to the measurement, the UE may report the corresponding sample index for the measurement. In one example, the UE may receive an indication to use the earliest sample as the reference timing. This may, for example, be sample index #1 in FIG. 9. In some cases, the UE may receive a request to use the sample corresponding to the highest power as the reference timing. This may, for example, be sample index #2 in FIG. 9. The UE may receive a time or sample offset, e.g., Noffset, to indicate the target timing. This may, for example, be Noffset=4 samples from the reference timing of sample. For example, if the target sample is #2 in FIG. 9, the target sample may be #6 for Noffset=4.

In some cases, the UE may receive more than one time or sample offsets, which may indicate a range or more than one target timing or samples. This may be, for example, Noffset=[4,6], indicating target samples are 4, 5 and 6 samples from the reference timing or sample. In this case the UE may make a determination to make measurements, for example phase measurement, for the indicated range or samples.

It is to be be noted that although the examples herein use OFDM symbols, the present disclosure should not be limited to the use of OFDM symbols. The methods, systems, and/or techniques described herein may be applicable to any type of symbols, such as DFT-spread OFDM, single carrier signals, or the like.

In some cases, the UE may receive a request from the network to report a phase difference measurement or measurements. In reporting such, the UE may report one or more of the following phase difference measurements: intra-symbol phase difference which is a phase difference between the reference and target timing within an indicated OFDM symbol index; inter-symbol phase difference which is a phase difference between OFDM symbol index #n and #m at the indicated timing, for example the indicated target timing, number of seconds or samples after the reference timing; and/or phase difference between DL-RSs transmitted from different TRPs.

In some cases, the UE may be configured with a parameter for symbol spacing. The UE may be configured with a symbol spacing parameter T per DL-RS configuration parameter, for example a DL-RS resource, and/or a DL-RS resource set. The UE may make a determination to make a phase difference measurement or measurements, for example inter-symbol phase difference, at indicated timings for the configured symbol spacing parameter. The symbol spacing parameter may indicate a separation between two OFDM symbols over which the phase difference measurement may be made.

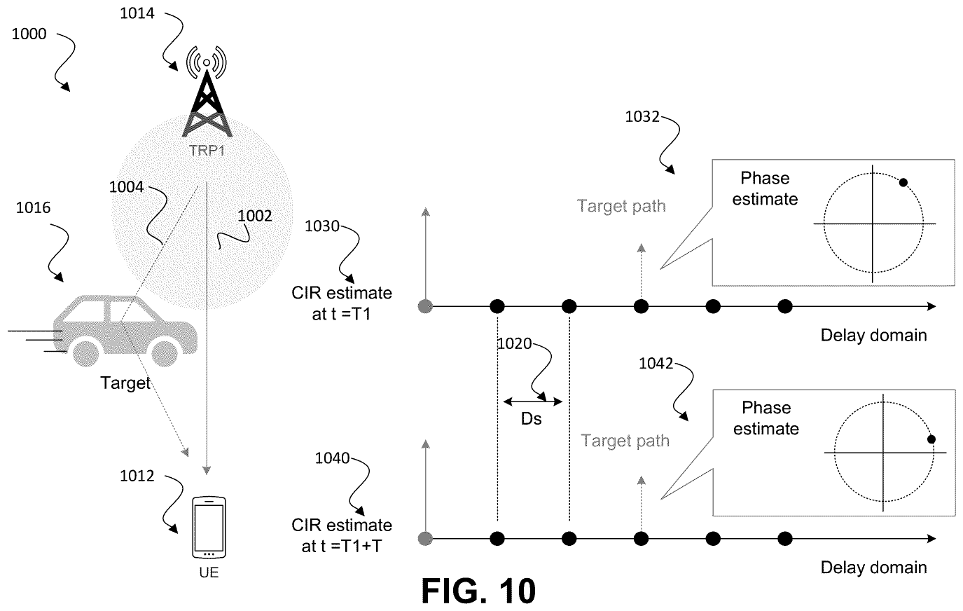

FIG. 10 shows an example of phase change in channel impulse responses across time. In the diagram 1000 shown in FIG. 10, phase difference measurement is illustrated, and as shown in FIG. 10, the UE 1012 may receive a DL-RS from TRP1 1014. The UE may estimate the channel impulse response (‘CIR’) using the OFDM symbol received at t=T1 and a representation of such a channel impulse chart is shown as a first channel impulse chart 1030. The UE may also estimate the CIR using the OFDM symbol received at t=T1+T, and a representation of such a channel impulse chart is shown as a second channel impulse chart 1040. In the example, the UE may observe two paths 1002, 1004 which may be a direct path 1002 and a reflected path 1004. The reflected path 1004 may be the target path, against the target 1016. In the example, sample granularity of the CIR is indicated by Ds 1020. Ds may be unitless or expressed in terms of a time unit, for example seconds, samples, or symbols. The CIR may, for example, be obtained by computing the IDFT or IFFT of the channel estimate made in the frequency domain.

The UE may receive an indication of which path or paths on which to make measurements. The UE may determine, according to a request or configuration from the network, power, phase and/or timing measurements. For example, the UE may receive a time difference, for example N ns, between a reference timing and target timing. The UE may be requested to make a phase measurement at N ns from the reference timing. The UE may receive an indication of the reference timing. For example, the UE may receive an indication of the location of the reference timing. For example, the reference timing may be M ns from the beginning of a time window (e.g., IFFT output). The UE may receive an indication from the network to set the reference timing as the first arrival path during a time window, or the strongest path in the time window.

As described herein, the terms “timing” and “path” may be used interchangeably. Similarly, as described herein the terms “configuration” or “preconfiguration” may be used interchangeably. As described herein, the terms “configured” or “preconfigured” may also be used interchangeably.

Referring to FIG. 10, the UE may receive a symbol spacing parameter, T, from the network. The unit of T may be seconds, symbols, slots, or the like. In the example illustrated in FIG. 10, the UE may measure the phase of the target timing for the symbol received at t=T and t=T1+T. The symbol at t=T1 and t=T1+T may be referred to as the first and second symbol, respectively. In some cases, the UE may be configured with a set of symbol spacing parameters. The UE may receive an indication from the network, among the set of values, which symbol spacing to use for Doppler estimation. In some cases, the UE may determine the value for the symbol spacing parameter from the set. The UE may indicate which value the UE used for estimation of Doppler frequency or for measurements, for example phase measurement.

The UE may compute the difference in the phase measured at the target path at first and second symbol. The unit of phase measurement may, for example, be in radians or degrees. A phase estimate for the CIR estimate at t=T1 is shown in the first phase estimate 1032 in FIG. 10, and a phase estimate for the CIR estimate at t=T1+t is shown in the second phase estimate 1042 in FIG. 10.

In the example, T1 and T1+T may be indicated by a symbol, slot, frame, or subframe index. For example, as illustrated in FIG. 10, the UE may receive an indication from the network to use the symbol index #1 in slot #X as the first symbol. The UE may receive an indication from the network to use the symbol index #4 in slot #X as the second symbol. The UE may receive an indication to report a phase difference between symbol index #4 and symbol index #1 at the target path. In this example, the symbol spacing is 3 symbols. A phase difference measurement may be expressed by θ_{D}=θ₂−θ₁ where θ₁ and θ₂ are phase measurements obtained from the first and second symbol, respectively.

In some cases, the UE may receive an explicit indication of location of the first and second symbols within a slot by symbol index in a configured duration, for example a slot. Using the indicated locations, the UE may determine the phase difference measurement. The UE may receive a request from the network to make more than one phase difference measurement. For example, the UE may be requested to carry out M phase difference measurements during a configured duration which may for example be a slot and/or a configured time window. The UE may receive symbol spacing and more than one locations of first symbol within a configured duration. For example, if there are 14 OFDM symbols in a slot and if one slot is the configured duration, the UE may receive symbol spacing of 3 symbols and symbol index #1, #2, #3, #4, #5, #6, #7, #8, #9, #10 and #11 as the locations of the first symbol. With such a configuration, the UE may report 11 phase difference measurements per slot to the network.

In some cases, the UE may receive a configuration for a symbol spacing and number of phase difference measurements to make within a configured duration. In this case, the UE may determine the location of the symbol index. When the UE reports a phase difference measurement or measurements, the UE may indicate the location or locations of the first symbol or symbols used to determine the phase difference measurement.

In an example, the UE may receive configurations for both symbol spacing and SCS from the network. The UE may receive an explicit message indicating symbol spacing, SCS and associated DL-RS configuration, for example DL-RS resource ID, to make measurements. In some cases, the UE may receive configurations associating symbol spacing and SCS. Thus, the UE may determine symbol spacing based on the configured SCS.

In some cases, the SCS and/or symbol spacing values may be indicated by RRC, MAC-CE or DCI. For example, the UE may be configured with a set of combinations of SCS and symbol spacing where each combination is associated with an index. The SCS may be associated with a DL-RS configuration. The UE may determine the SCS and symbol spacing to make measurements on based on the index indicated in MAC-CE or DCI.

In some cases, in order to solve the problem of phase wrapping between the measurements, the UE may associate the delay difference measurements between measurement occasions.

With reference to the example shown in FIG. 10, when the UE measures the phase difference PhaseDiff1 of the Target path between time T1 and T1+T, the UE may also measure the delay difference. The delay at time T1 may be taken as Delay1 between the reference and target paths. At T1+T, the UE may measure the Delay2 between reference and target paths. The UE may determine phase wrapping if the difference, for example the absolute value of the difference, between Delay1 and Delay2 is greater than (2π−PhaseDiff1). The UE may associate the delay difference to the phase measurements and report to the network.

In some cases, the UE may receive, from the network, more than one target timing. In such a case, the UE may report the phase difference between the reference timing and each of the target timings to the network.

In some examples, the UE may receive a range of timings for the target timing which may, for example include a lower and upper bound or bounds of a target timing. The UE may be configured or receive a request from the network to determine the target timing within the range or based on the range. The UE may report the determined timing to the network. The UE may make phase measurements, for example phase differential measurements, based on the determined timing.

In some cases, the UE may indicate the target timing or samples to be used to compute phase difference.

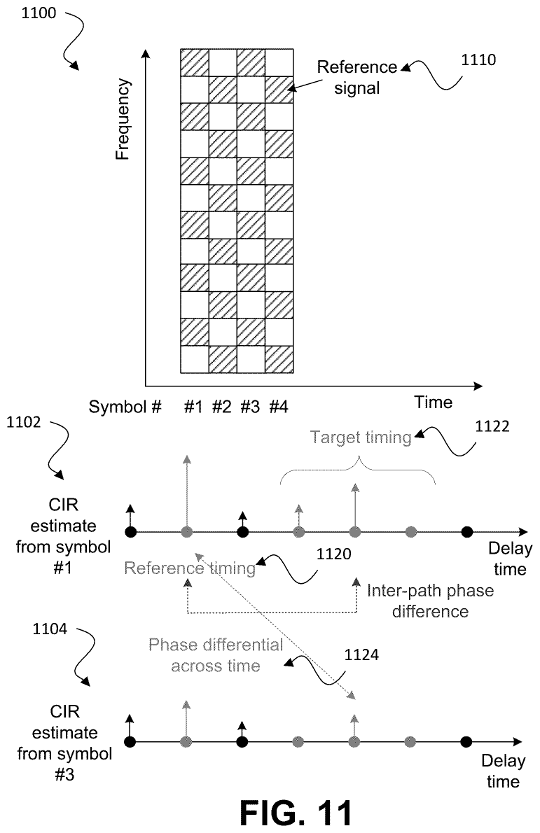

FIG. 11 shows an example of channel impulse responses at different symbols and differential phase measurements. In FIG. 11, a frequency and time graph 1100 is shown, which includes a sample of 4 OFDM symbols as part of a reference signal 1110. CIR estimate charts 1102 and 1104 are also shown. The OFDM symbols shown in the graph 1100 may consist of a comb-based RS, such that the location of the RS is shown in shaded squares in FIG. 11. The UE may estimate CIR per OFDM symbol using the received OFDM symbol #1 and #3. The UE may be configured by the network with the reference timing 1120 and target timings 1122. The UE may determine an intra-symbol phase difference 1124 by computing the difference between the phase of the reference and target timings. In the example shown in FIG. 11, since there are 3 target timings, the UE may determine 3 intra-symbol phase differences.

In some cases, the UE may determine a phase difference between the target timing of different symbols. For example, as illustrated in FIG. 10, the UE may determine the phase difference between the target timing at symbol #3 and the reference timing at symbol #1. In this example, since there are 3 target timings, the UE may determine 3 phase differences.

In the example shown in FIG. 10, the UE may determine the phase difference based on the phase measurements made on the 4th sample from the reference timing, for example the 1st sample in the example at the OFDM symbol at t=T1 and t=T1+T. The UE may receive a request to report the target timings used to determine phase difference measurements. In this case, the UE may report a pair of target timings used to determine the phase difference. For example, the UE may indicate that the target timing at the OFDM symbol at t=T1 may be the 4th sample from the reference timing. The target timing at the OFDM symbol at t=T1+t may be the 3rd sample from the reference timing.

In some cases, the UE may be configured to compute a phase difference at the target timing indicated by the network. If the UE determines that the target sampling is different from the timing indicated by the network duc to unexpected velocity of the target, or a timing shift at the UE, the UE may report the corrected target timing, with respect to the reference timing, to the network when the UE reports phase difference measurement.

In some cases, the UE may receive a request to perform both intra-symbol phase difference and inter-symbol phase difference. In this case, the UE may receive from the network symbol index k and j in addition to reference and target timing. The UE may first perform intra-symbol phase difference, φₖ for symbols #k and #j, and perform inter-symbol phase difference between symbol #k and #j, for example φₖ−φⱼ.

In some cases, the UE may determine timing, for example reference timing, based on the time of arrival. The UE may determine the time of arrival using more than one instance of DL-RSs, for example more than one DL-RS resource.

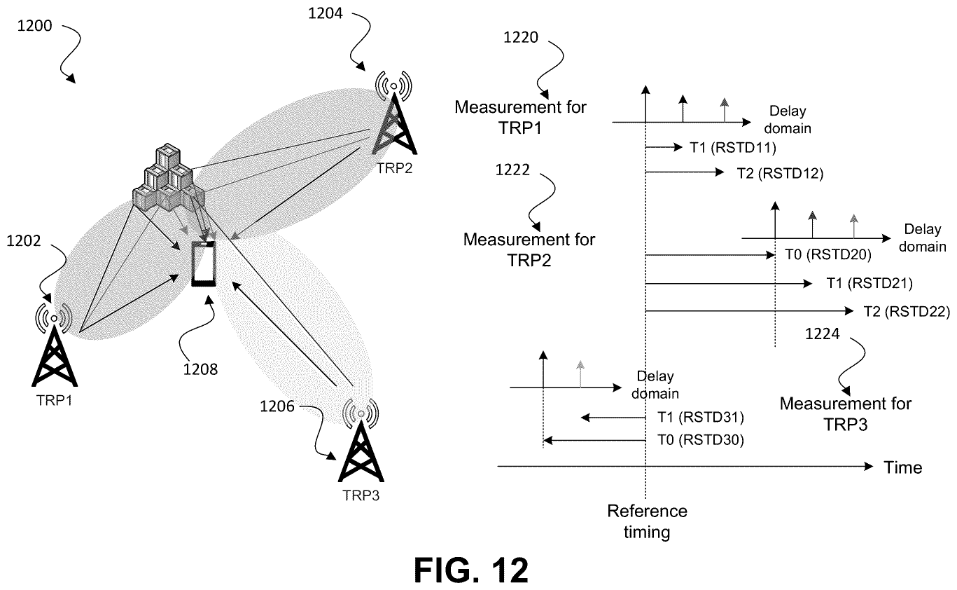

FIG. 12 shows an example of timing measurement. As shown the representative diagram 1200 in FIG. 12, the UE may be configured to receive DL-RS from 3 Transmission and Reception Points (‘TRPs’) 1202, 1204, 1206, which may be TRP1 1202, TRP2 1204, and TRP3 1206. The UE 1208 may measure 3 paths for the DL-RS transmitted from TRP1 1202. The UE may measure 3 paths for the DL-RS transmitted from TRP2 1204. Also, the UE may measure 2 paths for the DL-RS transmitted from TRP3 1204. A measurement 1220 for TRP1 1202, a measurement 1222 for TRP2 1204, and a measurement 1224 for TRP3 1206 is shown in FIG. 12.

In the example illustrated in the representative diagram 1200 of FIG. 12, a Reference Signal Time Difference (‘RSTD’) is indicated by RSTDij where “i” and “j” may indicate the TRP index and path index, respectively. In the example shown in FIG. 12, the UE may be configured with a reference TRP, TRP1 1202. In the example, the reference timing may be configured to be the first path observed through the DL-RS transmitted from TRP1 1202. The UE may determine RSTD11 based on the time of arrival of the first path and second path for the DL-RS transmitted from TRP1 1202. The UE may determine RSTD21 based on the difference between the time of arrival between the first path observed for the DL-RS received from TRP1 1202 and the second path observed in the DL-RS transmitted from TRP2 1204.

Similarly, the UE may determine RSTD31 based on the difference between the time of arrival of the first path for the DL-RS received from TRP1 1202 and the second path for the DL-RS received from TRP3 1206. In some cases, the UE may receive assistance information from the network such as relative delay in transmission of DL-RS between TRPs, for example TRP1 1202 and TRP2 1204, and/or relative phase difference between TRPs, for example TRP1 1202 and TRP2 1204 or the like.

The UE may receive a request, from the network, to report phase difference measurement and associate the phase difference measurement to the time difference measurement. The UE may make a determination to report a phase difference measurement or measurements between the reference path and target path and associate the phase difference measurement to the corresponding time difference. For example, the UE may make a determination to report the phase difference measurement between the phase measured at the first path, which may be the reference path, for the DL-RS received from TRP1 1202 and phase measured at the second path, which may be the target path, for the DL-RS received from TRP2 1204, and may associate the phase difference measurement to RSTD21.

As described herein, the terms “path”, “timing”, and/or “sample” may be used interchangeably.

In some cases, the UE may determine the reference timing and reference TRP. In such a case, the UE may report to the network the determined reference timing and reference TRP. In some cases, the UE may make a determination to report a timestamp associated with a phase difference measurement. The UE may make a determination to associate the timestamp to both the phase difference measurement and time difference measurement to indicate that the same reference timing is used for both phase difference and time difference measurement.

The reporting sent by the UE may include an estimated Doppler frequency, other measurements, such as channel impulse response (‘CIR’), an error case, for example if Doppler estimate cannot be obtained, and/or a timestamp.

In some cases, the UE may be configured to report a phase difference measurement. In some cases, the UE may receive a request from the network to report CIR. In such a case, the UE may be configured with a number of samples per CIR and measurements, for example power, timing, and/or phase, to make per sample. The UE may receive, from the network, an indication on conditions to report measurements. For example, the UE may receive a request to report measurements for samples with N highest RSRPs where the RSRP is measured per sample. The UE may be configured with a threshold and the UE may be configured to report measurements, for example phase measurements, for samples with corresponding measurements, for example power, over the configured threshold which may, for example, be a power threshold.

In one example, the UE may be configured to make an Angle of Arrival (‘AoA’) measurement per sample. The UE may be configured to make an AoA measurement for a sample or samples whose measurement, for example received power, is over the configured threshold. In some cases, the UE may make a determination to associate an AoA measurement with the phase measurement. For example, if a phase measurement is made per OFDM symbol, the UE may make a determination to make an AoA measurement per symbol. If the phase measurement is averaged over N OFDM symbols, the UE may make a determination to average an AoA measurement over the N OFDM symbols. In some cases, phase measurement and AoA measurement may not be made over the same quantity. For example, the UE may indicate whether AoA measurement is averaged or not. If the UE reports the average AoA measurement, the UE may report the number of occasions, for example slots and/or symbols, over which the AoA measurement is averaged.

The UE may be configured to associate an AoA with the estimated Doppler frequency. The UE may estimate the Doppler frequency per configured occasion, for example per slot, and/or per frame. The UE may report the estimated Doppler frequency with the AoA measurement. In some cases, the frequency of AoA measurements and the Doppler frequency may be different. For example, the UE may perform more frequent AoA measurements per estimate than for the Doppler frequency. In some cases, the UE may receive a request to include more than one AoA measurement or measurements per Doppler frequency estimate where periodicity, for example every N slot, every symbol, of the AoA measurement or an estimate may be configured by the network.

In some cases, the UE may receive an indication from the network to report processed, for example averaged, AoA measurements per Doppler frequency estimate. In some cases, the UE may make a determination to report more than one Doppler estimate per AoA measurement. The UE may receive a request or may be configured by the network to report processed Doppler estimates, for example an average of Doppler estimates, per AoA measurement.

In some cases, the UE may report uncertainty for measurements, for example phase and/or AoA measurements. Uncertainty for the measurement may be expressed in terms of standard deviation, variance, or range.

In some cases, the UE may include a timestamp in the measurement report. The timestamp may be expressed in terms of absolute time, relative time with respect to a reference timing, an SFN index, a symbol index, and/or slot index, for example. The timestamp may be associated with, for example, a phase measurement or measurements.

In some cases, the UE may make a determine to verify or validate the measurements associated with a sample if at least one of the following conditions is satisfied: the RSRP for the sample is over the configured threshold; an AoA for the sample is within a configured expected range of AoAs, where the expected range may be given by minimum and maximum AoA values in degrees or radians; and/or a difference for AoA for the sample for two OFDM symbols with a configured spacing, for example 1 OFDM symbol, or 2 OFDM symbols, is below a configured threshold, which may indicate that the direction of arrival of the reflected signal is consistent within a configured time window.

In some cases, the UE may report phase measurements if they are validated by other measurements, for example AoA measurements. The UE may report AoA measurements and its range if the phase measurements are not validated.

In some cases, the UE may receive a request to report details for each sample or path. In an example, the UE may be requested to report a LOS indicator for each sample or path. The UE may receive, from the network, sample indices or path indices for which the UE is requested to report LOS indicators.

In some cases, the UE may receive a request to report or recommend which sample or path may be used as the reference timing. The UE may receive a criterion from the network based on which the UE determines as being the reference timing or path. For example, the criterion may be a RSRP threshold, an AoA range, a LOS indicator, or the like.

In some cases, if the RSRP which corresponds to more than one timing or path or paths is above the RSRP threshold, the UE may make a determination to use the timing or path with highest RSRP or earliest time of arrival as the reference. If the AoA of more than one timing or path or paths is within the configured range of AoAs, the UE may make a determination to use the timing or path with the earliest time of arrival or strongest RSRP as the reference timing. For example, if the LOS indicator corresponding to more than one timing or path or paths is above the LOS threshold, the UE may make a determination to use the timing or path with highest RSRP or earliest time of arrival as the reference timing.

In some cases, the UE may receive a request to report the presence of the target for each sample or path. In such a case, the UE may determine whether the signal observed at the sample or path corresponds to reflected signal against a target. The UE may report sample or samples, range of samples, or path indices to the network, indicating that the reported sample or samples or path or paths include signals reflected against a target.

In some examples, the UE may report configurations, for example DL-RS resource ID or IDs, TRP ID or IDs, and/or SCS of the received DL-RS used to make measurements, for example phase measurements.

In some cases, the UE may make a determination to report measurement configurations used to make measurements, for example reference timing, target timing, number of samples in CIR, time of arrival information of reference timing or target timing.

In some cases, the UE may indicate to the network that a phase wrap-around occurred, for example the phase has rotated more than 360 degrees since the last measurement occasion, or reference measurement with respect to a differential measurement, for example phase difference measurement, is determined. In some cases, the UE may make a determination that phase wrap-around has occurred based on characteristics of the measurements, for example variations such as range or standard deviation of RSRP or time of arrival is above the threshold.

In some cases, the UE may be configured with the maximum range of Doppler frequencies to measure. In some cases, the UE may have a limitation or limitations on the maximum value or values of the Doppler frequency the UE may estimate or measure due to UE capabilities. The UE may indicate, to the network, in the measurement report that the estimated Doppler frequency or phase difference is above the measurable range of Doppler frequency or phase measurement. In some examples, the UE may report an error in the measurement report since the measurement or estimated Doppler frequency is above the measurable range of measurement or Doppler frequency.

In some cases, the UE may be configured to report an absolute phase measurement to the network. If the UE is requested to report the CIR, the UE may report phase measurement per sample. The UE may also receive a request to report absolute phase measurement at an indicated absolute or relative timing with respect to the reference timing.

In an example, the UE may determine to start measurements on DL-RSs when at least one of the following conditions is satisfied: the UE receives a request to start measurement; the UE is configured to start a measurement at configured time, for example N slots, after the UE receives, from the network, an indication to start measurement, for example via DCI; the UE receives an activation command for measurement, for example via MAC-CE; and/or the UE may be configured with a list of DL-RSs to make measurements on, and the UE may make a determination to measure the DL-RS if its RSRP is above the configured threshold.

In some cases, the UE may determine to terminate measurements on DL-RSs when at least one of the following conditions is satisfied: the UE makes the configured number of occasions of measurements, for example N phase measurements; a time duration of the time window expires; the UE condition changes during the consistency time window, for example the UE rotates; the UE may receive, from the network, an indication to stop measurement, for example via RRC; the UE may receive a deactivation command for measurements, for example via MAC-CE; if the RSPR for the DL-RS to make phase measurements on is below the configured threshold, the UE may determine to stop measurement on the DL-RS and/or report to the network RSRP; and/or if the LOS indicator for the DL-RS changes or becomes below the configured threshold, the UE may determine to stop phase measurement on the DL-RS and/or report to the network the determined LOS indicator.

In some cases, the UE may make a determination to process, for example average, the measurements before the UE reports measurements. For example, if the UE is configured to make N phase measurements during a configured duration, for example slot, the UE may determine one of the N phase measurements or average of the N phase measurements. The UE may make a determination to report one of the N phase measurements, if the UE determines that N phase measurements do not change during the configured duration or the variation, for example standard deviation or range of the phase measurement during the configured duration is below a configured threshold.

In some cases, the UE may compare a range against the threshold by determining the absolute value of the maximum and/or minimum value in the range and compare it against the threshold. The UE may indicate whether the reported phase measurements are an average of the N phase measurements or one of the N phase measurements in the measurement report.

In some cases, the UE may be configured to compute the average of phase measurements for the target timing based on the phase measurement over N OFDM symbols. N may be configured by the network. In some cases, the UE may make a determination to compute the average of differential phase measurements over N OFDM symbols. The differential phase measurement may be an intra-symbol differential phase measurement, for example a phase difference between the reference timing and target timing. In some cases, the differential phase measurement may be an inter-symbol differential phase measurement which may, for example, be a phase difference at the target timing between the kth and jth OFDM symbol.

In some examples, the UE may make a determination to find the average of phase measurements if at least one of the following conditions is satisfied: variations in phase measurements, for example a standard deviation, a variance, a range, is above the configured threshold; the UE receives a request from the network to average the phase measurement; an expected or estimated Doppler frequency is below the configured threshold; and/or an expected or estimated Doppler frequency is above the configured threshold. As described herein, “Doppler frequency”, “Doppler shift”, or “Doppler” may be used interchangeably.

In some cases, the UE may be configured to make measurements on DL-RSs at configured values of SCSs. The UE may determine the order of measurements. For example, the UE may be configured with the order of SCSs to make measurements, and in some examples, the UE may be configured with a set of SCSs or DL-RSs on which to make measurements. The UE may be configured to make measurements from the highest SCS in the set. In some cases, the UE may make a determination as to the order of SCS or the first SCS on which to make measurements, based on the estimated Doppler shift or expected Doppler shift provided by the network.

In some cases, if the estimated Doppler shift is above the configured threshold, the UE may make a determination to start measurements from the highest value of SCS in the configured set of SCS or DL-RSs.

Measurement details may, for example, include: averaging a phase difference, how the measurements are defined, measurement bundling; CIR, PDP, and/or DP precise definitions; an indication of which timing or range of timing to measure; and/or granularity of phase measurement controlled by two factors; SCS and distance between two OFDM symbols.

In some cases, the UE may be configured with a consistency window. A consistency window may be characterized by duration, for example the number of slots, a start and/or an end time. A consistency window may be periodic or semi-persistent or aperiodic. The UE may be configured with a periodicity. The UE may be configured with a start and/or stop time for a duration during which the windows are periodic. The UE may receive a trigger to initiate the aperiodic window via DCI. The UE may receive an activation command and/or a deactivation command for the window via MAC-CE.

The start and/or end time of the consistency window may be expressed in terms of absolute time, relative time with respect to a reference timing, SFN, frame index, slot index and/or symbol index. The UE may be configured with the window before the UE obtains DL-RS configurations from the network.

During a consistency window, the UE may be expected to maintain UE-side conditions, and the UE condition may be at least one or combination of the following; the UE or hardware, for example the antenna used to transmit or receive signals may not rotate or change orientation during the consistency window; the orientation angle of the UE during the window may be below a configured threshold; the UE may not move; the location of the UE may be changed during the window may be below a configured threshold; the UE does not switch, change or modify Rx or Tx hardware, for example an antenna; and/or if at least one of the above UE conditions is broken during the consistency window, the UE may make a determination that the consistency violation event is triggered.

In some cases, the UE may make a determination to report to the network if a consistency violation event is triggered. The content of the report may be at least one of the following: in the case of a consistency breaking event, for example mobility and/or rotation, the UE may indicate association between paths or timing compared to the previous time occasion or a new reference signal measurement; the UE may report to the network orientation information or location information, for example via a sensor, or information determined based on a RAT-dependent positioning method when the consistency condition is broken.

In some cases, the UE may indicate, for example via a flag in the report, that the UE moved or rotated which may, for example, be a flag value of “1” which may indicate that the UE moved or rotated, and if the UE does not move or rotate, the UE may not include the flag in the report. In some cases, the UE may indicate an error in the measurement. In some cases, the UE may detect a frequency offset, phase offset and/or timing offset in the measurement or refund or target timing.

In some cases, the UE may make a determination to stop measurements if the consistency violation event occurs during the consistency window. The UE may report, to the network, that the consistency violation event is triggered and may also report the cause which may, for example, be UE rotation. In an example, the UE may be configured with a range of values for tolerating a change in the UE side conditions based on which the UE determines whether the consistency condition is broken or not. For example, the UE may be configured with a threshold for rotation or orientation (e.g., 15 degrees). If the absolute value of the change in rotation or orientation is below or equal to the threshold, the UE may determine that the consistency condition is not broken. If the absolute value of the change in rotation or orientation is above the threshold, the UE may determine that the consistency condition is broken.

In some cases, the UE may make a determination to make measurements on the received DL-RS when a consistency violation event is triggered. In an example, the UE may be configured with a first set of measurement types and second set of measurement types. The UE may make a determination to make the first set of measurement types, for example phase measurement, and/or RSRP per path, to assist the network in estimating a Doppler frequency. The UE may make a determination to make the second set of measurement types, for example RSRP, if a consistency violation event is triggered.

In some cases, the UE may be configured with a consistency window before the UE is configured with DL-RSs to make measurements. The UE may receive a request from the network for measurements, and the request may include configurations for a consistency window. The UE may make a determination to accept, reject or acknowledge the request. If the UE accepts the request, the UE may receive, from the network, configurations for a consistency window.

In some cases, the UE may receive from the network a set of configurations for a consistency window where each set may consist of different start and/or stop times, durations, and or periodicity. The set may be configured via a higher layer signal, for example RRC and/or LPP. Each configuration for the window may be associated with a unique index. The UE may receive an activation command or deactivation command from the network, for example via MAC-CE, indicating the index.

A consistency window may have a duration or associated validity timer. The UE may make a determination to stop measurement after the consistency window is terminated, for example the end of the duration of the consistency window may be reached or the validity timer for the consistency window expires. The UE may make a determination to start the validity timer for the window when the UE initiates measurements on the configured DL-RSs.

For example, the UE may receive configurations for a consistency window per DL-RS configuration, for example a DL-RS resource, a TRP, and/or a cell. For example, the UE may be expected to maintain UE-side conditions during the measurement of an indicated DL-RS or DL-RSs transmitted from the indicated TRP or cell.

In some cases, during the configured consistency window, the UE may prioritize transmission of UL signals or channels or reception of DL signals or reception. For example, if UL signals, for example SRS and/or channels, for example PUCCH and/or PUSCH are scheduled to be transmitted during the consistency window, the UE may make a determination to cancel the scheduled uplink transmission. The UE may not receive scheduled DL signals, for example CSI-RS and/or DL channels, for example PDCCH and/or PDSCH during the configured consistency window.

In some cases, the UE may prioritize reception or transmission of certain signals or channels. For example, the UE may receive a SSB during the configured consistency window. The UE may make a determination to transmit a high priority PUCCH channel, for example UCI and/or SR. If the UE receives a DL signal and/or channels or transmit UL signals or channels during the configured consistency window, the UE may stop the window. In some cases, the UE may send an indication or request to the network to restart the window if at least one of the following conditions is satisfied: the UE is able to maintain consistency during reception or transmission of DL signals and/or channels or UL signals and/or channels; and/or a duration of DL signals and/or channel transmission or UL signals and/or channel reception is shorter than the configured threshold.

In some cases, the restarted window may not be updated with a new end time or duration. In some cases, the network may indicate to the UE that the restarted window has a new end time or duration to supplement missed time for the interruption for receiving DL signals and/or channels or transmitting UL signals/channels.

In some cases, the measurement and measurement reporting may be divided into two phases. During a first phase, the UE may report measurements to the network so that the network may determine suitable DL-RSs for Doppler estimation. During a second phase, the UE may be triggered by the network to make measurements to assist the network to estimate the Doppler shift of a mobile target.

In some cases, the UE may be configured with a first set of DL-RSs or DL-RS resources to make measurements. The UE may receive a request from the network to make measurements. The UE may report the first set of measurements, which may for example include time measurement, power measurement, and/or phase. The UE may report multipath measurements which may, for example, include timing per path, power per path to the network if the UE detects multiple paths in the measurements. The UE may be configured with a window consisting of N samples and the UE may be requested to report measurements per sample or report measurement for the sample which satisfies a condition, for example the RSRP for the sample is above the threshold.

In some cases, the network may determine a suitable set of DL-RSs to make measurements for the second phase of measurement. The aforementioned suitable set of DL-RSs may contain LOS paths, for example.

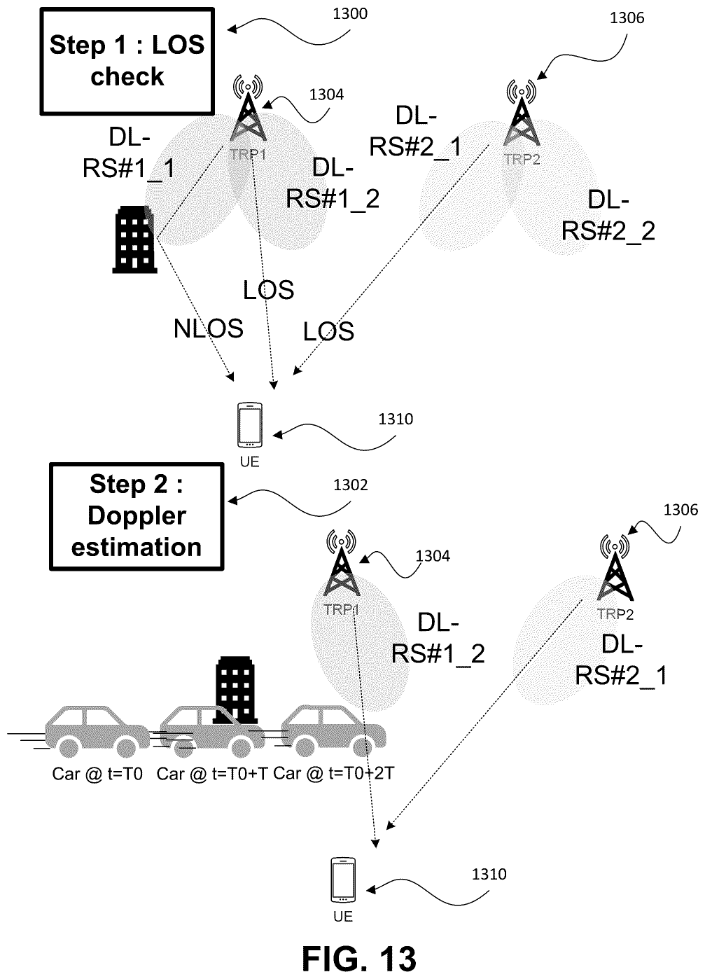

FIG. 13 shows an example of line of sight (‘LOS’) check 1300 and Doppler estimation 1302. In both the LOS check 1300 and the Doppler estimation 1302 shown in the example in FIG. 13, the UE 1310 may make measurements on transmitted DL-RSs from 2 TRPs, namely TRP1 1304 and TRP2 1306. In the example illustrated in FIG. 13, there may be 4 DL-RSs configured for the UE to make measurements, namely DL-RS #1_1, DL-RS #1_2, DL-RS #2_1 and DL-RS #2_2. The example may also include 2 DL-RSs, DL-RS #1_2 and DL-RS #2_1, which are in LOS and one DL-RS, DL_RS #1_1, in NLOS.

The network or UE may determine LOS status for each DL-RS based on the measurements. The UE may receive an indication from the network to make measurements on DL-RSs in LOS. As illustrated in FIG. 13, the UE may make measurements on DL-RSs, DL-RS #1_2 and DL-RS #2_1, which are LOS in the presence of a target which may, for example, be a mobile car. The UE may make measurements which may, for example include phase, timing, and/or power at timing t=T0, t=T0+T and t=T0+2T on the received DL-RS.

In some cases, the UE may be configured to make two types of measurements, a first type and a second type. While the first type of measurement may be used by the network to determine suitable DL-RSs to measure for Doppler estimation, for example LOS DL-RS, the second type of measurement may be used by the network to estimate the Doppler frequency.

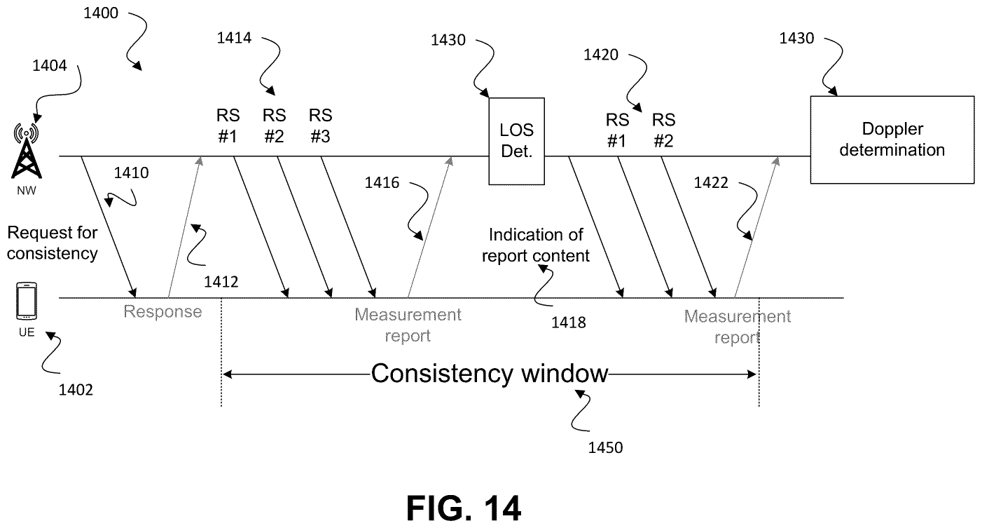

FIG. 14 shows an example of interaction between a WTRU and a network. In the example diagram 1400 shown in FIG. 14, the UE 1402 may receive a request for consistency 1410 from the network 1404. The UE 1402 may send a response 1412 to the network 1404 which may, for example, be accept, reject, and/or acknowledgment.

The UE 1402 may receive first DL-RSs 1414 from the network 1404. The UE 1402 may report 1416 the measurement of the first type which may include, for example, power, timing, CIR, and/or multipath measurements made on the first set of DL-RSs. The UE 1402 may receive an indication 1418 of the DL-RSs to make measurement of the second type, which may, for example, be power per path and/or relative timing of each path made on the second set of DL-RSs. The second set of DL-RSs 1420 may be a subset of the first set of DL-RSs. The UE 1402 may send a second measurement report 1422 to the network 1404. The UE 1402 may receive configuration of DL-RSs from the network 1404 prior to receiving the DL-RSs. The UE 1402 may also receive configurations for a consistency window 1450 which may, for example, be a start/end time and/or a duration during which the UE 1402 is expected to maintain UE conditions.

In some cases, the UE 1402 may be requested to report LOS status 1430 for the first set of DL-RSs. This may, for example, be a hard or soft LOS indicator for DL-RS, a hard or soft LOS indicator for configured TRPs, and/or recommended DL-RSs for mobility detection or estimation, and/or Doppler frequency estimation 1440.

In some cases, the UE 1402 may receive a request, from the network 1404, to report the LOS indicator for a configured TRP. In such a case, the UE 1402 may report a LOS indicator and corresponding TRP ID, for example LOS status between the UE 1402 and TRP with the TRP ID).

In some cases, if requested by the network, the UE 1402 may report a LOS indicator for a set of DL-RSs where the network may indicate, to the UE 1402, the set of DL-RSs. This may, for example, include LOS status 1430 along a set of DL-RSs where the set of DL-RSs may be transmitted in a similar spatial direction.

Once the UE 1402 reports 1412 the first set of measurements, the UE 1402 may receive a request to make a second set of measurements for a second set of DL-RSs. The second set of DL-RSs may be a subset of the first set of DL-RSs. The second set of measurements may, for example, contain phase measurement.

The UE 1402 may receive an activation command or initiation command from the network to make the second set of measurements.

In some cases, the UE 1402 may make both the first and second set of measurements during the configured consistency window 1450. If a consistency violation event is triggered, the UE 1402 may report the details of the event as explained herein.

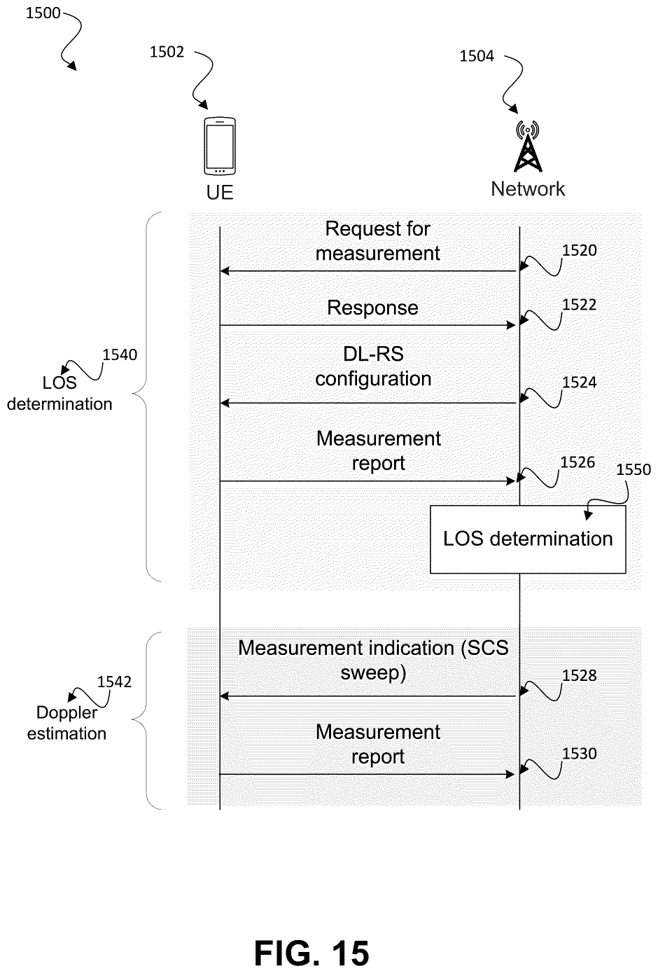

FIG. 15 shows an exemplary signaling diagram illustrating signal flow between a WTRU and a network for Doppler estimation. In the exemplary signaling diagram 1500 shown in FIG. 15, the network may, for example, be a gNB.

In the diagram 1500 shown in FIG. 15, a UE 1502, which may, for example be the WTRU 102 of FIG. 1B, may receive a request 1520 for the first set of measurements from the network 1504. The UE 1502 may send a response 1522, for example accept or reject, to the network 1504. The UE 1502 may receive a configuration 1524 for the first set of DL-RSs, and first measurement configuration and consistency time window from the network 1504. The UE 1502 may report 1526 the first set of measurements to the network 1504. The UE 1502 may receive 1528, from the network 1504, configurations for a second set of DL-RSs and second measurement configuration to make the second set of measurements. The UE 1502 may report 1530 measurements to the network 1504.

In the example shown in FIG. 15, steps 1520, 1522, 1524, and 1526 may form LOS determination steps 1540 and result in LOS determination 1550. Steps 1528 and 1530 may form Doppler estimation steps 1542.

In the example shown in FIG. 15, the first measurement configuration may contain a measurement type, for example a power, a timing, a CIR, a PDP, and/or a DP. The second measurement configuration may contain the measurement type and additional assistance information for the UE to make a specific measurement which may, for example, be a phase measurement. For example, the additional assistance information may be relative timing with respect to specific timing in the estimated channel impulse response where the UE is expected to make phase measurement at the relative timing.

In some cases, the first and second set of DL-RSs may include DL-RSs for more than one SCSs so that the UE can report measurements, for example phase, for each of the configured SCS.

Some examples may include an on-demand request for SCS, and in such an example the UE may receive configuration for the first set of DL-RSs and first measurement configuration. Based on the measurement the UE may send a request to the network for reconfiguration of DL-RSs. The UE may include preferred configuration parameters for DL-RS which may, for example, include a number of TRPs, DL-RS resource IDs, spatial direction, number of repetitions, periodicity.

Some examples may include a report and NW reply, which may be described as reconfiguration, and in such an example the UE may receive the first set of DL-RSs and first measurement configuration. After the UE reports the measurements on the first set of DL-RSs, the UE may receive the second set of DL-RSs where the second set of DL-RSs may not overlap with the first set of DL-RSs. The UE may determine to follow the first measurement configuration for the second set of DL-RSs.

Based on the measurement reports on more than one SCSs from the UE, the network may be able to eliminate ambiguity in Doppler shift estimation and may make an accurate determine of movement and/or mobility of a target.

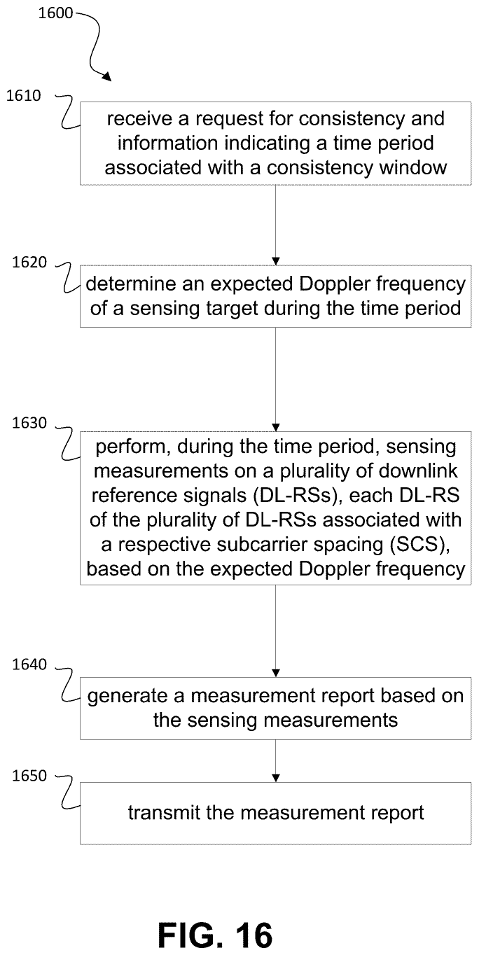

FIG. 16 is a flow diagram illustrating a method 1600 for determining a Doppler frequency according to one or more embodiments. The method 1600 may, for example, be carried out by the WTRU 102 of FIG. 1B. The method 1600 may include step 1610. At step 1610, the WTRU may receive a request for consistency and information indicating a time period associated with a consistency window. The WTRU may receive the request for consistency, and the information indicating the time period associated with a consistency window, from the network.

The method 1600 may include step 1620. At step 1620, the WTRU may determine an expected Doppler frequency of a sensing target during the time period associated with the consistency window. The estimated Doppler frequency may be determined by the WTRU using techniques described herein. In some cases, the Doppler frequency may be provided to the WTRU by the network. As described herein, the time period may be, for example, a period measured in nanoseconds, milliseconds, seconds, frames, symbols, or similar, and may be taken as a period for which the WTRU is expected to be compliant with consistency parameters as described herein.

The method 1600 may include step 1630. At step 1630, the WTRU may perform, during the time period, sensing measurements on a plurality of downlink reference signals (DL-RSs), with each DL-RS of the plurality of DL-RSs associated with a respective subcarrier spacing (SCS), based upon the expected Doppler frequency. The plurality of DL-RSs and respective subcarriers may be configured as described in and with reference to FIG. 7 herein. The respective SCSs may be, for example, 15 kHz, 30 kHz, and/or 60 KHz.

The method 1600 may include step 1640. At step 1640, the WTRU may generate a measurement report based on the sensing measurements. The report may include measurements generated as described herein.

The method 1600 may include step 1650. At step 1650, the WTRU may transmit, to the network, the measurement report. The measurement report may transmit the measurement report to the network using techniques as described herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without unduc experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU) in communication with a wireless network, the method comprising:
receiving, from the wireless network, a request for consistency, and information indicating a time period associated with a consistency window;
determining an expected Doppler frequency of a sensing target during the time period;
performing, during the time period, sensing measurements on a plurality of downlink reference signals (DL-RSs), each DL-RS of the plurality of DL-RSs associated with a respective subcarrier spacing (SCS), based on the expected Doppler frequency;
generating a measurement report based on the sensing measurements; and
transmitting the measurement report to the wireless network.

2. The method of claim 1, wherein the information indicating the time period comprises a time duration for which consistency must be maintained.

3. The method of claim 1, further comprising:
receiving, from the wireless network, a request to report information about a location of the WTRU; and
transmitting, to the wireless network, information indicative of the location of the WTRU.

4. The method of claim 1, wherein determining the expected Doppler frequency of the sensing target during the time period comprises at least one of receiving, from the wireless network, the expected Doppler frequency, or estimating the expected Doppler frequency.

5. The method of claim 1, wherein performing the sensing measurements comprises:
identifying the plurality of DL-RSs, the respective SCSs, and a plurality of orthogonal frequency division multiplexing (OFDM) symbol indices associated with the plurality of DL-RSs based on the expected Doppler frequency; and
measuring a temporal separation between two OFDM symbols of corresponding OFDM symbol indexes of the plurality of OFDM symbol indices.

6. The method of claim 1, wherein the plurality of DL-RSs comprise a second plurality of DL-RSs, the respective SCSs comprise second respective SCSs, the measurements comprise second measurements, and the measurement report comprises a second measurement report, the method further comprising, prior to determining an expected Doppler frequency of a sensing target:
performing first sensing measurements on a first plurality of DL-RSs, each associated with a first respective SCS based on the time period;
generating a first measurement report based on the first sensing measurements; and
transmitting the first measurement report to the wireless network.

7. The method of claim 6, further comprising:
determining that a consistency condition is violated during the time period;
based on determining that the consistency condition is violated during the time period:
performing third sensing measurements on the first plurality of DL-RSs, each associated with a first respective SCS;
generating a third measurement report based on the third sensing measurements; and
transmitting the third measurement report to the wireless network.

8. The method of claim 1, wherein the wireless network uses the measurement report to determine a velocity of the sensing target.

9. The method of claim 1, further comprising:
determining at least one of the following conditions is met:
the expected Doppler frequency is below a threshold, or
a standard deviation of a received power of a DL-RS from the plurality of DL-RSs is above a threshold; and
based on determining that the at least one of the conditions is met:
determining an average of the sensing measurements; and
transmitting to the wireless network, as part of the measurement report, the average.

10. The method of claim 1, wherein the expected Doppler frequency is received from the wireless network, the method further comprising:
generating an estimated Doppler frequency;
determining whether the estimated Doppler frequency corresponds to the expected Doppler frequency; and
transmitting to the wireless network, as part of the measurement report, an indication of whether the estimated Doppler frequency corresponds to the expected Doppler frequency.

11. A wireless transmit/receive unit (WTRU) in communication with a wireless network, the WTRU comprising:
a processor; and
a transceiver coupled to the processor, wherein the WTRU is configured to:
receive, from the wireless network, a request for consistency, and information indicating a time period associated with a consistency window;
determine an expected Doppler frequency of a sensing target during the time period;
perform, during the time period, sensing measurements on a plurality of downlink reference signals (DL-RSs), each DL-RS of the plurality of DL-RSs associated with a respective subcarrier spacing (SCS), based on the expected Doppler frequency;
generate a measurement report based on the sensing measurements; and
transmit the measurement report to the wireless network.

12. The WTRU of claim 11, wherein the information indicating the time period comprises a time duration for which consistency must be maintained.

13. The WTRU of claim 11, wherein the WTRU is further configured to:
receive, from the wireless network, a request to report information about a location of the WTRU; and
transmit, to the wireless network, information indicative of the location of the WTRU.

14. The WTRU of claim 11, wherein determining the expected Doppler frequency of the sensing target during the time period comprises the WTRU receiving, from the wireless network, the expected Doppler frequency, or the WTRU estimating the expected Doppler frequency.

15. The WTRU of claim 11, wherein performing the sensing measurements comprises:
the WTRU identifying the plurality of DL-RSs, the respective SCSs, and a plurality of orthogonal frequency division multiplexing (OFDM) symbol indices associated with the plurality of DL-RSs based on the expected Doppler frequency; and
the WTRU measuring a temporal separation between two OFDM symbols of corresponding OFDM symbol indexes of the plurality of OFDM symbol indices.

16. The WTRU of claim 11, wherein the plurality of DL-RSs comprise a second plurality of DL-RSs, the respective SCSs comprise second respective SCSs, the measurements comprise second measurements, and the measurement report comprises a second measurement report, and the WTRU is further configured to, prior to determining an expected Doppler frequency of a sensing target:
perform first sensing measurements on a first plurality of DL-RSs, each associated with a first respective SCS based on the time period;
generate a first measurement report based on the first sensing measurements; and
transmit the first measurement report to the wireless network.

17. The WTRU of claim 16, wherein the WTRU is further configured to:
determine that a consistency condition is violated during the time period;
based on determining that the consistency condition is violated during the time period:
perform third sensing measurements on the first plurality of DL-RSs, each associated with a first respective SCS;
generate a third measurement report based on the third sensing measurements; and
transmit the third measurement report to the wireless network.

18. The WTRU of claim 11, wherein the wireless network uses the measurement report to determine a velocity of the sensing target.

19. The WTRU of claim 11, wherein the WTRU is further configured to:
determine at least one of the following conditions is met:
the expected Doppler frequency is below a threshold, or
a standard deviation of a received power of a DL-RS from the plurality of DL-RSs is above a threshold; and
based on determining that the at least one of the conditions is met:
determine an average of the sensing measurements; and
transmit to the wireless network, as part of the measurement report, the average.

20. The WTRU of claim 11, wherein the expected Doppler frequency is received from the wireless network, the WTRU further configured to:
generate an estimated Doppler frequency;
determine whether the estimated Doppler frequency corresponds to the expected Doppler frequency; and
transmit to the wireless network, as part of the measurement report, an indication of whether the estimated Doppler frequency corresponds to the expected Doppler frequency.
